(19) United States
(12) Patent Application Publication
(10) Pub. No.: US 2003/0144899 A1
(43) Pub. Date: Jul. 31, 2003

(54) Questionnaire collection method, a questionnaire collection program, and a questionnaire collection apparatus

(75) Inventor: Yoshiyuki Kokubo, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/175,314

(22) Filed: Jun. 20, 2002

(30) Foreign Application Priority Data
Jan. 28, 2002 (JP) 2002-018731

(51) Int. Cl. G06F 17/60

(52) U.S. Cl. 705/10; 707/9; 705/14

(57) ABSTRACT

A questionnaire collection method capable of efficiently collecting questionnaires on products or services provided by a plurality of corporations and presenting the results of questionnaire responses for comparison between the products or services provided by different corporations. Questions to be adopted in a questionnaire on each of products or services, which are provided by a plurality of corporations and which are subjects of questionnairing, are registered (Step S1). Customers' responses to the questions in the questionnaires on the products or services are accepted via a network, following a uniform input procedure (Step S2). The results of responses to the questions are displayed for comparison between products or services provided by different corporations (Step S3).

### BACKGROUND OF THE INVENTION

(1) Field of the Invention

The present invention relates to a method, program and apparatus for collecting questionnaires from customers, and more particularly, to a method, program and apparatus for collecting questionnaires via a network.

(2) Description of the Related Art

In order to improve the qualities of services or products that corporations provide to customers, it is essential for such corporations to have an accurate grasp of customers' satisfaction. One of methods for investigating the customer satisfaction is to collect questionnaires from customers.

For example, customers who received service or product are requested to fill out questionnaires prepared for the investigation of satisfaction. Such questionnaires will include questions about customers themselves, and questions about the product. Customer-related questions may be concerned with customer's name, age, address, hobby, etc., and product-related questions may be concerned with purpose of purchase, impressions of the product after use, etc. By collecting such questionnaires, it is possible for the corporation to grasp customers' satisfaction.

In many cases, questionnaire postcards are used for collecting questionnaires. Questionnaire postcards are handed to customers when service or product is provided, for example. At a later date, customers fill in answers to the questions and mail the questionnaire postcards, which are then delivered to the corporation. In the case of computer software or the like, questionnaires are often collected on-line via the Internet.

The more respondents respond to the questionnaire, the more accurately the customer satisfaction can be grasped. Desirably, therefore, questionnaires should be collected from as many customers as possible.

However, whether to respond to a questionnaire or not is at the disposal of the customer, and moreover, it takes time to fill in answers to the questions. Accordingly, simply handing questionnaire postcards to customers does not guarantee high-rate collection of questionnaire postcards.

Thus, many corporations use questionnaire postcards also as entry forms for prize competition to invite customers to fill out and mail the questionnaire postcards, with a view to increasing the collection rate of questionnaire postcards. Also, to collect a desired number of questionnaires without fail, some corporations attempt offering higher-priced prizes or increasing the number of prize winners. This makes it easier to collect a large number of questionnaire responses and to obtain investigation results accurately showing the customer satisfaction.

Conventionally, however, questionnairing is conducted by individual corporations, and it is therefore impossible for a corporation to compare the results of questionnairing conducted thereby with the results of questionnairing conducted by another corporation. For example, a corporation cannot find out whether the degree of customer satisfaction with its product is higher than that with a competing product.

Also, in cases where questionnairing is conducted by individual corporations, the items of questions in the questionnaire and the method of response vary from corporation to corporation. If the items of questions or the method of response differs from corporation to corporation, a consumer as a respondent must be well aware of the meanings of the questions or the method of sending a response (e.g. by postcard or via the Internet) each time he/she responds to a questionnaire, increasing the burden on the consumer. This lessens the consumers' incentive to respond to questionnaires and makes it difficult for corporations to collect questionnaires as they wish. If higher-priced prizes are offered to improve the collection rate of questionnaires, then the economic burden on corporations unduly increases.

### SUMMARY OF THE INVENTION

The present invention was created in view of the above circumstances, and an object thereof is to provide a questionnaire collection method which is capable of efficiently collecting questionnaires on products or services provided by a plurality of corporations and which permits comparison between the results of questionnairing on products or services provided by different corporations.

To achieve the object, there is provided a questionnaire collection method implemented by a computer connected to a network. The questionnaire collection method comprises registering questions to be adopted in a questionnaire on each of products or services provided by a plurality of corporations, accepting via the network responses of customers to the questions in the questionnaires on the products or the services, and displaying results of responses to the questions for comparison between the products or the services provided by the plurality of corporations.

The present invention also provides a questionnaire collection program for collecting questionnaires from customers. The questionnaire collection program causes a computer to perform the process of registering questions to be adopted in a questionnaire on each of products or services provided by a plurality of corporations, accepting via a network responses of the customers to the questions in the questionnaires on the products or the services, and displaying results of responses to the questions for comparison between the products or the services provided by the plurality of corporations.

Further, the present invention provides a questionnaire collection apparatus for collecting questionnaires from customers. The questionnaire collection apparatus comprises registration means for registering questions to be adopted in a questionnaire on each of products or services provided by a plurality of corporations, response accepting means for accepting via a network responses of the customers to the questions in the questionnaires on the products or the services, and display means for displaying results of responses to the questions for comparison between the products or the services provided by the plurality of corporations.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram illustrating the invention applied to embodiments;

FIG. 2 is a conceptual diagram illustrating an embodiment of the present invention;

FIG. 3 is a block diagram showing a hardware configuration of a questionnaire collection server;

FIG. 4 is a functional block diagram of the questionnaire collection server;

FIG. 5 is a diagram showing an exemplary data structure of a product DB;

FIG. 6 is a diagram showing an exemplary data structure of a question master DB;

FIG. 7 is a diagram showing an exemplary data structure of a question content DB;

FIG. 8 is a diagram showing an exemplary data structure of a response DB;

FIG. 9 is a diagram showing an exemplary data structure of an entry DB;

FIG. 10 is a diagram showing an exemplary data structure of a member DB;

FIG. 11 is a diagram showing an exemplary data structure of a temporary storage section;

FIG. 12 is a flowchart illustrating an overall flow of a questionnaire collection process;

FIG. 13 is a first flowchart illustrating a procedure for a questionnaire item acceptance process;

FIG. 14 is a second flowchart illustrating the procedure for the questionnaire item acceptance process;

FIG. 15 is a third flowchart illustrating the procedure for the questionnaire item acceptance process;

FIG. 16 is a fourth flowchart illustrating the procedure for the questionnaire item acceptance process;

FIG. 17 is a diagram showing an example of a product information input screen;

FIG. 18 is a diagram showing an example of a question content selection screen;

FIG. 19 is a first flowchart illustrating a procedure for a questionnaire response acceptance process;

FIG. 20 is a second flowchart illustrating the procedure for the questionnaire response acceptance process;

FIG. 21 is a diagram showing an example of a CS code input screen;

FIG. 22 is a diagram showing an example of a questionnaire response input screen;

FIG. 23 is a diagram showing an example of a prize destination input screen;

FIG. 24 is a diagram showing an example of a completion notification screen;

FIG. 25 is a first flowchart illustrating a procedure for a questionnairing result notification process;

FIG. 26 is a second flowchart illustrating the procedure for the questionnairing result notification process;

FIG. 27 is a diagram showing an example of a response statistics screen;

FIG. 28 is a first flowchart illustrating a procedure for an automatic updating process;

FIG. 29 is a second flowchart illustrating the procedure for the automatic updating process; and

FIG. 30 is a third flowchart illustrating the procedure for the automatic updating process.

### DESCRIPTION OF THE PREFERRED EMBODIMENTS

Embodiments of the present invention will be hereinafter described with reference to the drawings.

First, the invention applied to the embodiments will be outlined, and then the embodiments of the present invention will be described in detail.

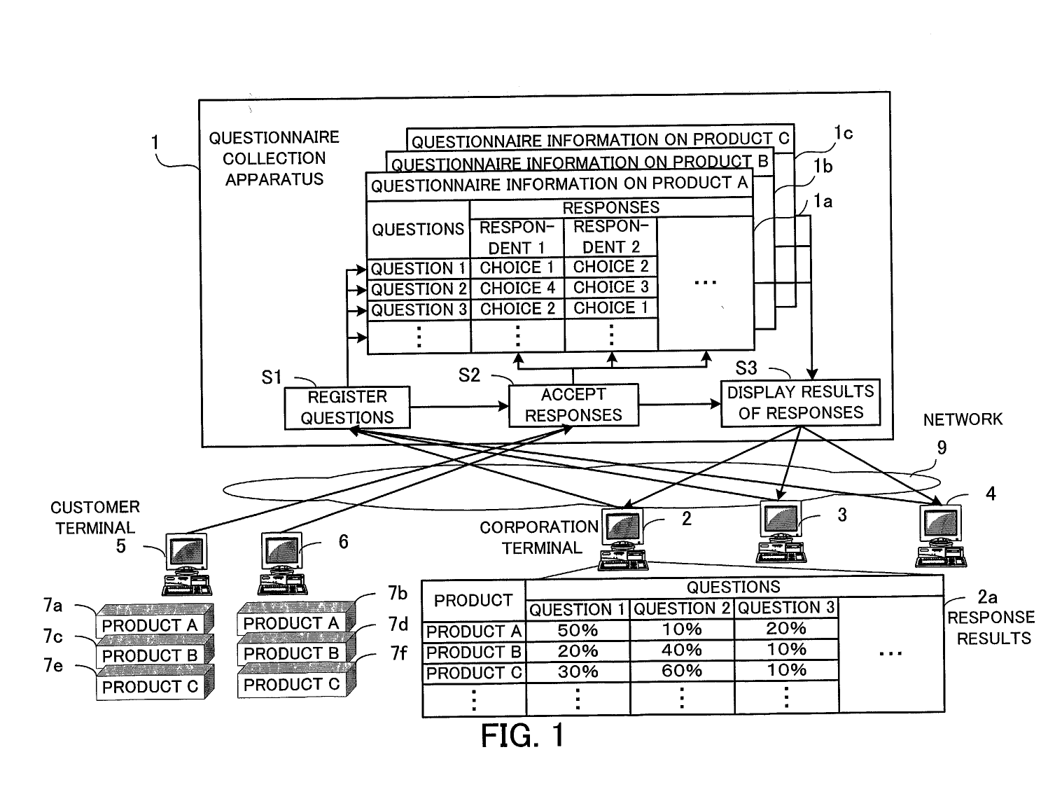

FIG. 1 is a conceptual diagram illustrating the invention applied to the embodiments. As shown in FIG. 1, a questionnaire collection apparatus 1, a plurality of corporation-side terminal devices (corporation terminals) 2-4 and a plurality of customer-side terminal devices (customer terminals) 5, 6 are interconnected by a network 9.

The questionnaire collection apparatus 1, which is a computer for collecting questionnaires via the network 9, holds multiple questionnaire information 1a-1c associated with respective types of products 7a-7f. The questionnaire information 1a-1c includes questions, responses to the questions, etc.

The corporation terminals 2-4 are computers installed at respective corporations. For example, the corporation terminal 2 is installed at a corporation which sells the products 7a, 7b (product name: “PRODUCT A”), the corporation terminal 3 is installed at a corporation which sells the products 7c, 7d (product name: “PRODUCT B”), and the corporation terminal 4 is installed at a corporation which sells the products 7e, 7f (product name: “PRODUCT C”).

The customer terminals 5, 6 are devices owned by customers who use products or services provided by the corporations. Each of the customer terminals 5, 6 has at least the function of accessing the questionnaire collection apparatus 1 via the network 9. The customer terminals 5, 6 comprise, for example, portable telephones, personal digital assistants (PDAs), personal computers or the like. For example, the customer terminal 5 is used by a customer who purchased the products 7a, 7c, 7e, and the customer terminal 6 is used by a customer who purchased the products 7b, 7d, 7f.

With the configuration described above, the questionnaire collection apparatus 1 first registers questions to be adopted in a questionnaire on each of products or services provided by a plurality of corporations (Step S1). For example, the questionnaire collection apparatus 1 accepts, from the corporation terminals 2-4, questions to be adopted in questionnaires on the products 7a-7f sold by the corporations. Then, the questionnaire collection apparatus 1 registers the questions sent from the corporation terminals 2-4 as contents of the questionnaires on the respective products 7a-7f.

Subsequently, following a uniform input procedure, the questionnaire collection apparatus 1 accepts via the network 9 customers' responses to the questions in the questionnaires on the products 7a-7f (or services) (Step S2). For example, responses to the questionnaires on the products 7a-7f, input by the users of the customer terminals 5, 6, are accepted. The responses thus accepted are registered as the questionnaire information 1a-1c.

Further, the questionnaire collection apparatus 1 displays the results of responses to the questions for comparison between the multiple products 7a-7f or services provided by different corporations (Step S3). For example, the questionnaire collection apparatus 1 transmits the response results to the corporation terminals 2-4 via the network 9, to have the response results 2a displayed on the screens of the corporation terminals 2-4.

In this manner, responses to the questionnaires on the products 7a-7f or services provided by a plurality of corporations are collected by the questionnaire collection apparatus 1, so that customers have only to follow a uniform procedure to respond to the questionnaires on products provided by different corporations. As a consequence, it is possible to mitigate the customers' burden of responding to questionnaires from a plurality of corporations and to efficiently collect questionnaire responses. Further, the results of responses to questionnaires are displayed for comparison between the products provided by different corporations, and this enables a corporation to find out whether the degree of customer satisfaction with its product is higher than that with competing products.

The questionnaire collection apparatus 1 shown in FIG. 1 can be implemented by a computer. As one embodiment of the present invention, therefore, a server computer provided with the function of the questionnaire collection apparatus 1 will be explained in detail by way of example. In the following, the server computer having the function of the questionnaire collection apparatus 1 is referred to as questionnaire collection server.

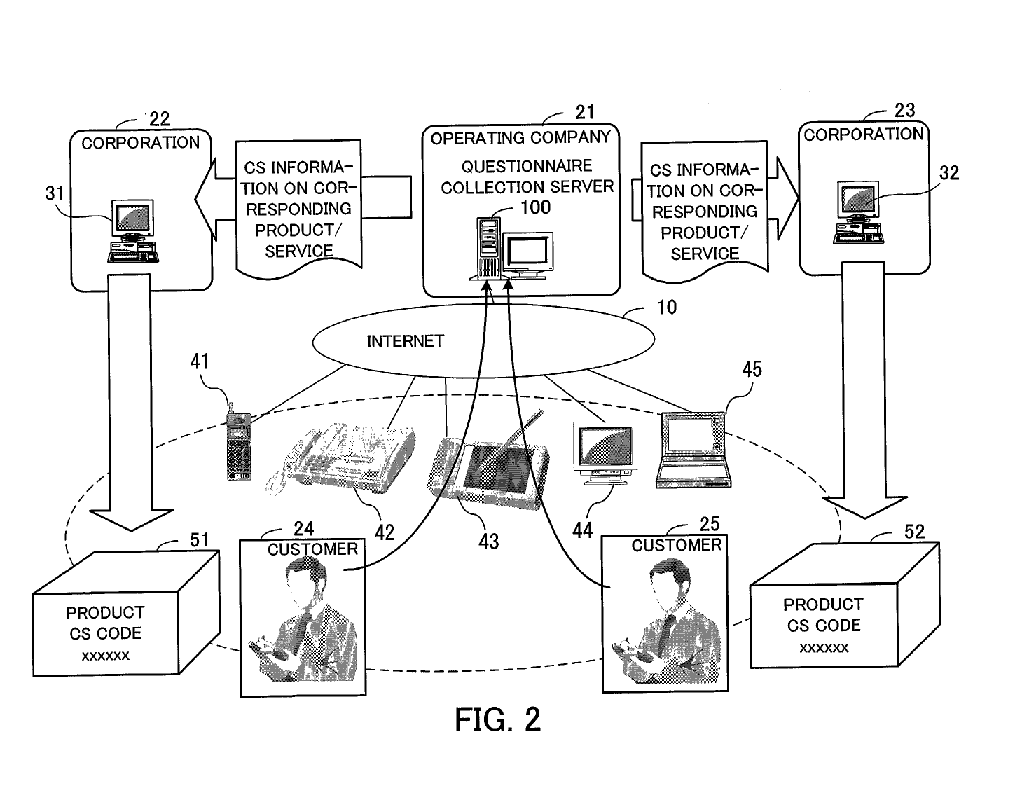

FIG. 2 is a conceptual diagram illustrating the embodiment. In this embodiment, a questionnaire collection server 100, corporation terminals 31, 32, and customer terminals 41-45 are interconnected via the Internet 10. The questionnaire collection server 100 is under the management of an operating company 21 that provides questionnaire collection service. The corporation terminals 31, 32 are computers owned by respective corporations 22, 23 which provide products or services to customers 24, 25. The customer terminals 41-45 are information terminals used by general consumers, and may be browser phones (portable or fixed telephones having the Web browsing function), PDAs, Web TVs (television sets having the Web browsing function), personal computers (PCs), etc.

The corporations 22, 23 request the operating company 21 to collect questionnaires, and also notify the customers 24, 25 of identification information (CS (Customer Satisfaction) codes) on products 51, 52 as well as the address of a Web site (CS site) for entering questionnaire responses. For example, the corporations 22, 23 print CS codes and the homepage address of the CS site on packages of the products 51, 52 to be provided to the customers 24, 25. As the CS code, JAN (Japanese Article Number) code, for example, is used. The JAN code is a common article code used in Japan. The homepage address of the CS site is indicated, for example, by a URL (Uniform Resource Locator). The CS site is a Web site provided within the questionnaire collection server 100.

Using the customer terminals 41-45, the customers 24, 25 who purchased the products 51, 52 access the questionnaire collection server 100 by means of the homepage address printed on the packages etc. of the products 51, 52. The customers 24, 25 then input the CS code to the customer terminals 41-45, whereupon the CS code is transmitted to the questionnaire collection server 100. Subsequently, the questionnaire collection server 100 transmits the contents of a questionnaire, or questions, to the customer terminals 41-45, and the questions are displayed on the screens of the customer terminals 41-45.

The customers 24, 25 input, to the customer terminals 41-45, responses to the respective questions displayed on the screens of the customer terminals 41-45. The responses thus input are transmitted from the customer terminals 41-45 to the questionnaire collection server 100 and stored therein.

The responses input by the multiple customers 24, 25 are added up by groups in the questionnaire collection server 100 to generate customer satisfaction information (CS information) on the products 51, 52. The CS information includes information indicating the degrees of customer satisfaction with the respective products sold by different corporations. Then, the corporations 22, 23 are notified of the CS information in which the results of questionnairing are displayed for comparison between the products provided by different corporations. For example, the results of classified totaling of the responses are transmitted from the questionnaire collection server 100 to the corporation terminals 31, 32 via the Internet 10.

In the case of offering prizes to questionnaire respondents, the operating company 21 draws lots and sends prizes to prize-winning customers.

Thus, the corporations 22, 23 can compare the degrees of customer satisfaction with the products 51, 52 with each other.

Also, the customers 24, 25 have only to access one CS site to respond to questionnaires on the products 51, 52 provided by the different corporations 22, 23, making it easy for customers to respond to questionnaires.

The function of the questionnaire collection server 100 for operating the aforementioned system will be now described.

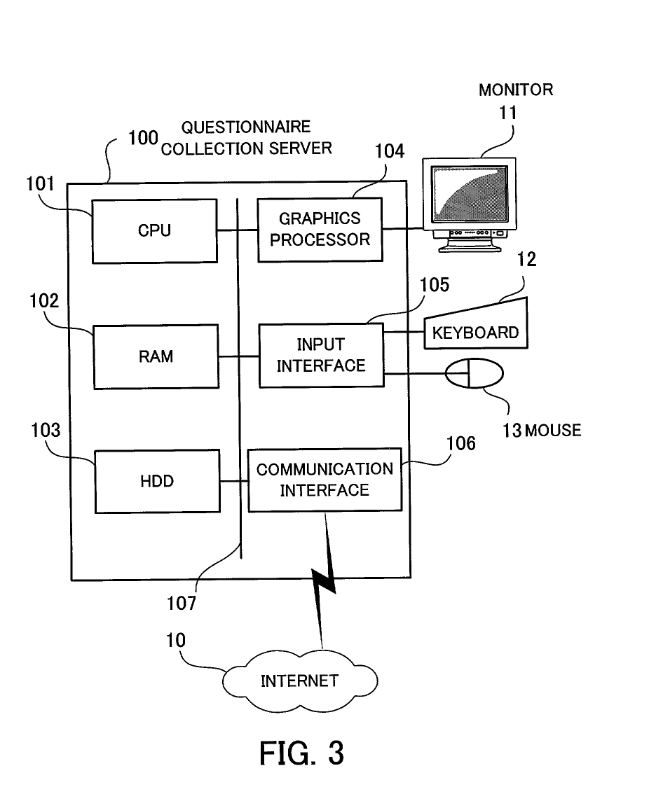

FIG. 3 is a block diagram showing a hardware configuration of the questionnaire collection server. The questionnaire collection server 100 includes a CPU (Central Processing Unit) 101 whereby the whole server is controlled. To the CPU 101 are connected, via a bus 107, a RAM (Random Access Memory) 102, a hard disk drive (HDD) 103, a graphics processor 104, an input interface 105, and a communication interface 106.

The RAM 102 temporarily stores OS (Operating System) programs and at least part of application programs executed by the CPU 101. The RAM 102 also stores various data necessary for the processing by the CPU 101. The HDD 103 stores the OS and application programs.

The graphics processor 104 is connected with a monitor 11. In accordance with instructions from the CPU 101, the graphics processor 104 displays images on the screen of the monitor 11. The input interface 105 is connected with a keyboard 12 and a mouse 13. The input interface 105 supplies signals input thereto from the keyboard 12 and the mouse 13 to the CPU 101 via the bus 107.

The communication interface 106 is connected to the Internet 10 and transmits/receives data to/from other computers via the Internet 10.

With the hardware configuration described above, the processing function of this embodiment is accomplished. Although FIG. 3 shows the hardware configuration of the questionnaire collection server 100, the corporation terminals 31, 32 and the customer terminals 41-45 also may have similar hardware configuration. However, where the customer terminals 41-45 are telephones, a telephone function (wireless or wired) is additionally provided, and where the customer terminals 41-45 are Web TVs, a television receiving function is additionally provided.

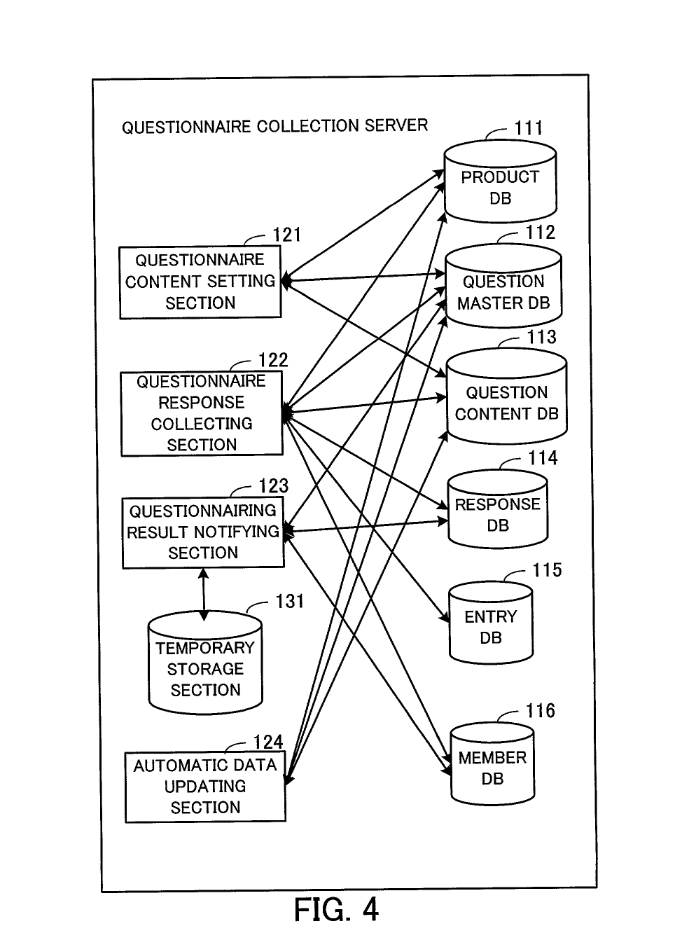

FIG. 4 is a functional block diagram of the questionnaire collection server. The questionnaire collection server 100 has a product database (DB) 111, a question master database (DB) 112, a question content database (DB) 113, a response database (DB) 114, an entry database (DB) 115, a member database (DB) 116, a questionnaire content setting section 121, a questionnaire response collecting section 122, a questionnairing result notifying section 123, and an automatic data updating section 124. During execution of the process, a temporary storage section 131 is created in the RAM 102. Of these component elements, those exchanging information are connected to each other.

The product DB 111 is a database in which is registered information about products with respect to which the operating company 21 has been requested to collect questionnaires. The question master DB 112 is a database in which is registered a list of questions to be adopted in questionnaires. The question content DB 113 is a database in which are registered contents of questions in individual questionnaires on respective products. The response DB 114 is a database in which are registered customers' responses to the individual questionnaires. The entry DB 115 is a database in which is registered information about participants who participated in a prize competition when submitting questionnaires. The member DB 116 is a database in which is registered information about customers who are registered as members.

The questionnaire content setting section 121 communicates with the corporation terminals 31, 32 and registers contents of questionnaires on products. Specifically, in compliance with requests from the corporation terminals 31, 32, the questionnaire content setting section 121 registers, in the product DB 111, information about the products with respect to which customer satisfaction is to be investigated. Also, the questionnaire content setting section 121 permits the corporation terminals 31, 32 to select questions to be adopted in questionnaires on the registered products, from among the questions registered in the question master DB 112. The questionnaire content setting section 121 registers information about the selected questions in the question content DB 113 in a manner associated with the respective products. Also, the questionnaire content setting section 121 updates values in the question master DB 112 which indicate the numbers of corporations (selecting corporations) that selected the respective questions.

The questionnaire response collecting section 122 communicates with the customer terminals 41-45 to collect responses to the questions in the questionnaires. Specifically, in compliance with requests from the customer terminals 41-45, the questionnaire response collecting section 122 registers, in the response DB 114, the responses to the questions in the questionnaires. Also, the questionnaire response collecting section 122 registers, in the entry DB 115, information about the customers who replied to the questions in the questionnaires.

In the case where a condition has been set that a question should be added to the questionnaire only if the number of corporations that selected the question is greater than or equal to a threshold, the automatic data updating section 124 periodically counts, with respect to each of the questions, the number of corporations that selected the question. When the number of corporations that selected a question has become greater than the threshold which is set for each of the products, the automatic data updating section 124 registers the question in the question content DB 113 as one of the questions in the questionnaire on the product concerned.

The temporary storage section 131 is a storage area where information constituting the results of questionnairing is stored when the questionnairing results are transmitted to corporations. Input/output of data to/from the temporary storage section 131 is carried out by the questionnairing result notifying section 123.

Exemplary data structures of the individual databases constructed in the questionnaire collection server 100 will be now described.

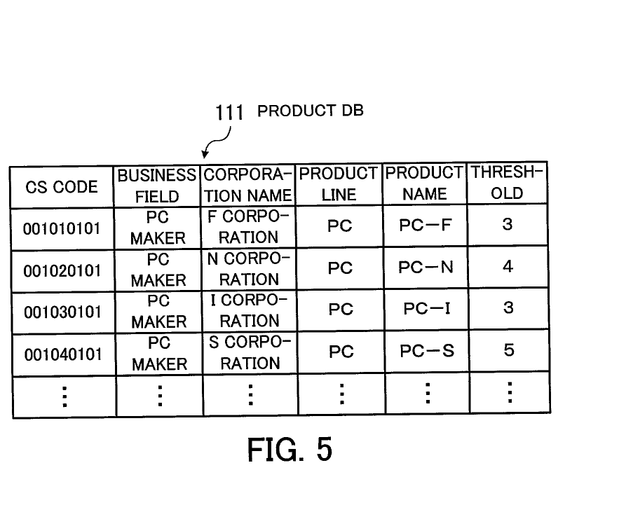

FIG. 5 illustrates an exemplary data structure of the product DB. The product DB 111 has registered therein information about the products which are the subjects of questionnairing. The product DB 111 is provided with columns “CS CODE”, “BUSINESS FIELD”, “CORPORATION NAME”, “PRODUCT LINE”, “PRODUCT NAME”, and “THRESHOLD”. Items of information in each row across the columns are associated with one another and constitute a record.

The “CS CODE” column has set therein the CS codes constituting identification information of respective products which are the subjects of questionnairing. The “BUSINESS FIELD” column has set therein the business categories to which corporations selling the respective products belong, and the “CORPORATION NAME” column has set therein the names of corporations which sell the respective products. The “PRODUCT LINE” column has set therein the types (product lines) of the respective products as the subjects of questionnairing, and the “PRODUCT NAME” column has set therein the names (product names) of the respective products. In the “THRESHOLD” column are set the numbers of selecting corporations (thresholds) which are used as conditions for adopting questions in questionnaires. Questions selected by more corporations than the thresholds are preferentially adopted in questionnaires. It is also possible to make settings such that the condition indicated by the threshold is ignored.

In the example of FIG. 5, for the product with the CS code “001010101”, “PC (Personal Computer) MAKER” is set as the business field, “F CORPORATION” as the corporation name, “PC” as the product line, “PC-F” as the product name, and “3” as the threshold. For the product with the CS code “001020101”, “PC MAKER” is set as the business field, “N CORPORATION” as the corporation name, “PC” as the product line, “PC-N” as the product name, and “4” as the threshold. For the product with the CS code “001030101”, “PC MAKER” is set as the business field, “I CORPORATION” as the corporation name, “PC” as the product line, “PC-I” as the product name, and “3” as the threshold. For the product with the CS code “001040101”, “PC MAKER” is set as the business field, “S CORPORATION” as the corporation name, “PC” as the product line, “PC-S” as the product name, and “5” as the threshold.

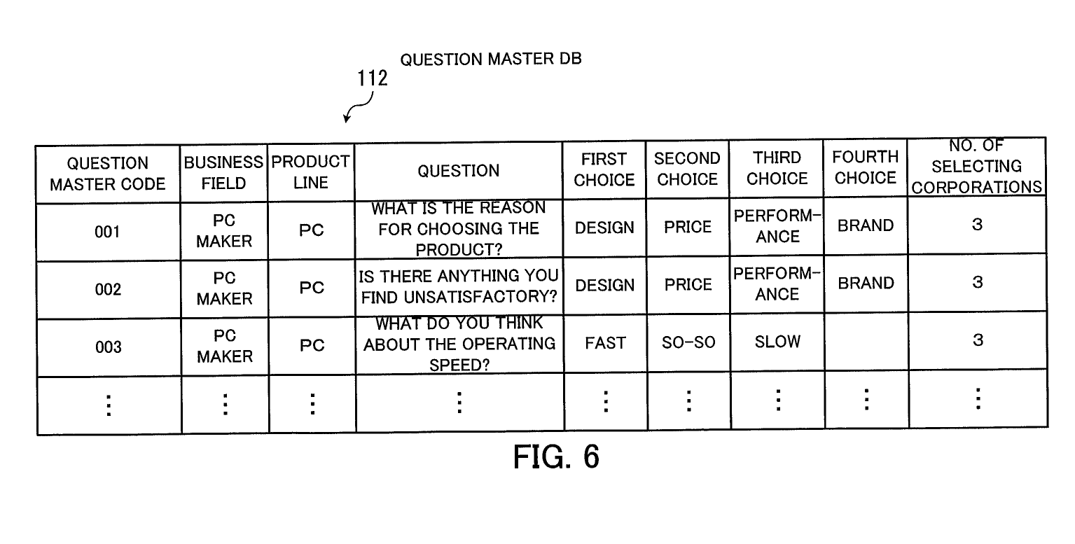

FIG. 6 illustrates an exemplary data structure of the question master DB. In the question master DB 112 are set questions that may be adopted in questionnaires and choices to be selected to answer the respective questions. The question master DB 112 is provided with columns “QUESTION MASTER CODE”, “BUSINESS FIELD”, “PRODUCT LINE”, “QUESTION”, “FIRST CHOICE”, “SECOND CHOICE”, “THIRD CHOICE”, “FOURTH CHOICE”, and “NO. OF SELECTING CORPORATIONS”. Items of information in each row across the columns are associated with one another and constitute a record.

The “QUESTION MASTER CODE” column has set therein identifiers (question master codes) for identifying the respective questions. The “BUSINESS FIELD” column has set therein business fields as assumed targets to which the respective questions are directed, and the “PRODUCT LINE” column has set therein product lines as assumed targets to which the respective questions are directed. The “QUESTION” column has set therein character strings indicating the contents of the respective questions. The “FIRST CHOICE” column has set therein character strings indicating first choices (choice number “1”) to be selected to answer the respective questions, and the “SECOND CHOICE” column has set therein character strings indicating second choices (choice number “2”) to be selected to answer the respective questions. Similarly, the “THIRD CHOICE” column has set therein character strings indicating third choices (choice number “3”) to be selected to answer the respective questions, and the “FOURTH CHOICE” column has set therein character strings indicating fourth choices (choice number “4”) to be selected to answer the respective questions. In the example of FIG. 6, four choices can be set, but one or more choices may be left unused. Alternatively, five or more choices may be provided. The “NO. OF SELECTING CORPORATIONS” column has set therein the numbers of corporations that have selected the respective questions.

In the example of FIG. 6, for the question with the question master code “001”, “PC MAKER” is set as the business field, “PC” as the product line, “WHAT IS THE REASON FOR CHOOSING THE PRODUCT?” as the question, “DESIGN” as the first choice, “PRICE” as the second choice, “PERFORMANCE” as the third choice, “BRAND” as the fourth choice, and “3” as the number of selecting corporations. For the question with the question master code “002”, “PC MAKER” is set as the business field, “PC” as the product line, “IS THERE ANYTHING YOU FIND UNSATISFACTORY?” as the question, “DESIGN” as the first choice, “PRICE” as the second choice, “PERFORMANCE” as the third choice, “BRAND” as the fourth choice, and “3” as the number of selecting corporations. For the question with the question master code “003”, “PC MAKER” is set as the business field, “PC” as the product line, “WHAT DO YOU THINK ABOUT THE OPERATING SPEED?” as the question, “FAST” as the first choice, “SO-SO” as the second choice, “SLOW” as the third choice, the fourth choice is left undefined, and “3” is set as the number of selecting corporations.

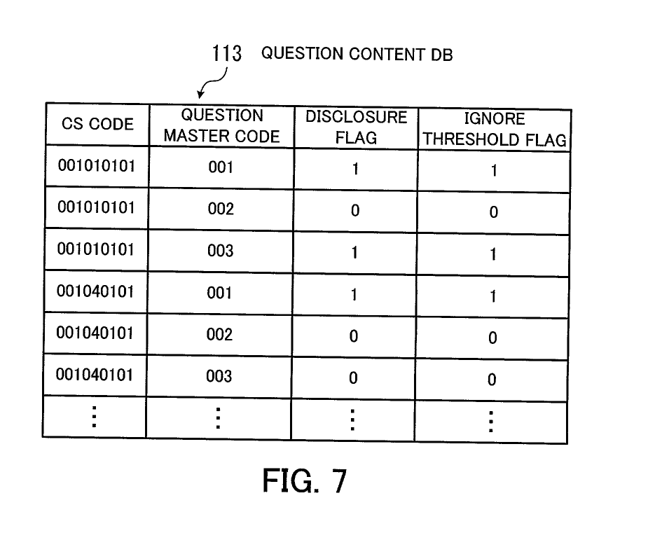

FIG. 7 illustrates an exemplary data structure of the question content DB. In the question content DB 113 are set questions selected in questionnaires on the respective products. The question content DB 113 is provided with columns “CS CODE”, “QUESTION MASTER CODE”, “DISCLOSURE FLAG” and “IGNORE THRESHOLD FLAG”. Items of information in each row across the columns are associated with one another and constitute a record.

The “CS CODE” column has set therein the CS codes of products to which respective questions are directed, and the “QUESTION MASTER CODE” column has set therein the question master codes of questions adopted in the questionnaires on the products specified by the respective CS codes. The “DISCLOSURE FLAG” column has set therein flags (disclosure flags) indicating whether or not customers' responses to the respective questions may be disclosed to other corporations. For example, if “1” is set for the disclosure flag, the corresponding response is disclosed to other corporations; if “0” is set for the disclosure flag, the response is not disclosed to other corporations. The “IGNORE THRESHOLD FLAG” column has set therein flags (ignore threshold flags) indicating whether or not the threshold is to be ignored when determining whether to adopt the respective questions. If “1” is set for the ignore threshold flag, the threshold set with respect to the corresponding product is ignored, and if “0” is set for the ignore threshold flag, the threshold set with respect to the corresponding product takes effect.

In the example of FIG. 7, for the questionnaire on the product with the CS code “001010101”, the question with the question master code “001” is adopted with the disclosure flag and the ignore threshold flag both set to “1”, the question with the question master code “002” is adopted with the disclosure flag and the ignore threshold flag both set to “0”, and the question with the question master code “003” is adopted with the disclosure flag and the ignore threshold flag both set to “1”. For the questionnaire on the product with the CS code “001040101”, the question with the question master code “001” is adopted with the disclosure flag and the ignore threshold flag both set to “1”, the question with the question master code “002” is adopted with the disclosure flag and the ignore threshold flag both set to “0”, and the question with the question master code “003” is adopted with the disclosure flag and the ignore threshold flag both set to “0”.

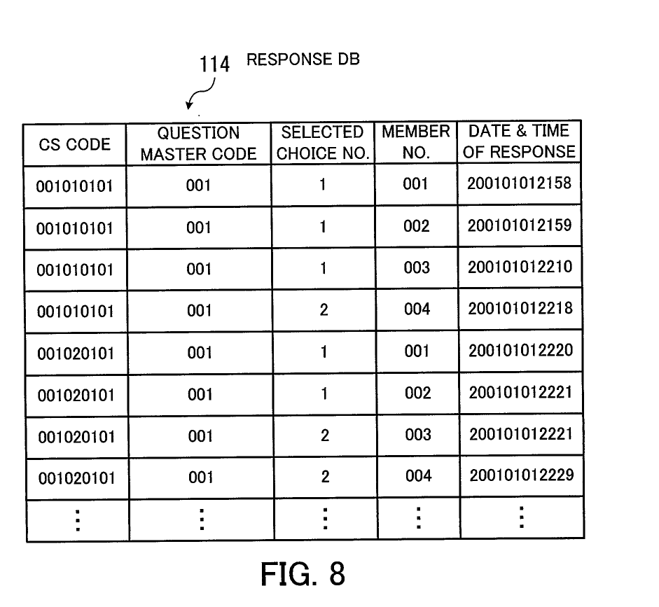

FIG. 8 illustrates an exemplary data structure of the response DB. In the response DB 114 are set responses from customers to questions in the questionnaires on the respective products. The response DB 114 is provided with columns “CS CODE”, “QUESTION MASTER CODE”, “SELECTED CHOICE NO.”, “MEMBER NO.” and “DATE & TIME OF RESPONSE”. Items of information in each row across the columns are associated with one another and constitute a record.

The “CS CODE” column has set therein the CS codes of products with respect to which the corresponding questions have been answered, and the “QUESTION MASTER CODE” column has set therein the question master codes of the respective answered questions. The “SELECTED CHOICE NO.” column has set therein the choice numbers selected in the respective responses, and the “MEMBER NO.” column has set therein the member numbers of customers who answered the respective questions. The “DATE & TIME OF RESPONSE” column has set therein the dates and times at which the respective responses were made.

For example, in reply to the question with the question master code “001” about the product with the CS code “001010101”, the member with the member number “001” selected the choice number “1” at 21:58 on Jan. 1, 2001 (date and time of response: “200101012158”).

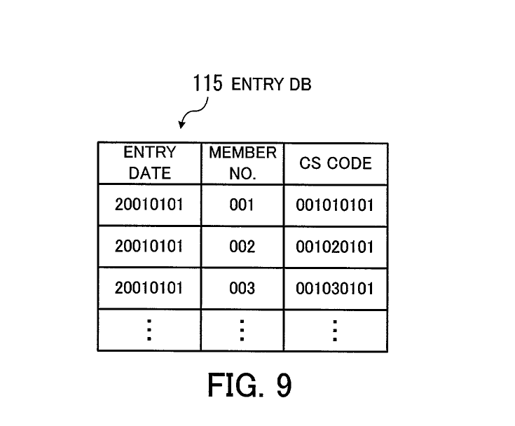

FIG. 9 illustrates an exemplary data structure of the entry DB. The entry DB 115 is a database in which is registered a list of participants who participated in prize competitions for the respective products. The entry DB 115 is provided with columns “ENTRY DATE”, “MEMBER NO.” and “CS CODE”. Items of information in each row across the columns are associated with one another and constitute a record. Each time a response to the questionnaire on a product is accepted, a corresponding record is appended to and registered in the entry DB 115.

The “ENTRY DATE” column has set therein the dates on which the respective entries into prize competition were accepted. In this embodiment, the date of acceptance of a questionnaire response is regarded as the date of entry into prize competition.

The “MEMBER NO.” column has set therein the member numbers of respective members who participated in prize competition. In this embodiment, the member numbers of members who transmitted questionnaire responses are set in this column.

The “CS CODE” column has set therein the CS codes of the respective products with respect to which prize competition is carried on. In this embodiment, the CS codes of the products which are the subjects of questionnairing and with respect to which responses have been received are set in this column.

For example, the member with the member number “001” participated in the competition for prizes offered in relation to the product with the CS code “001010101”, on Jan. 1, 2001 (entry date: “20010101”).

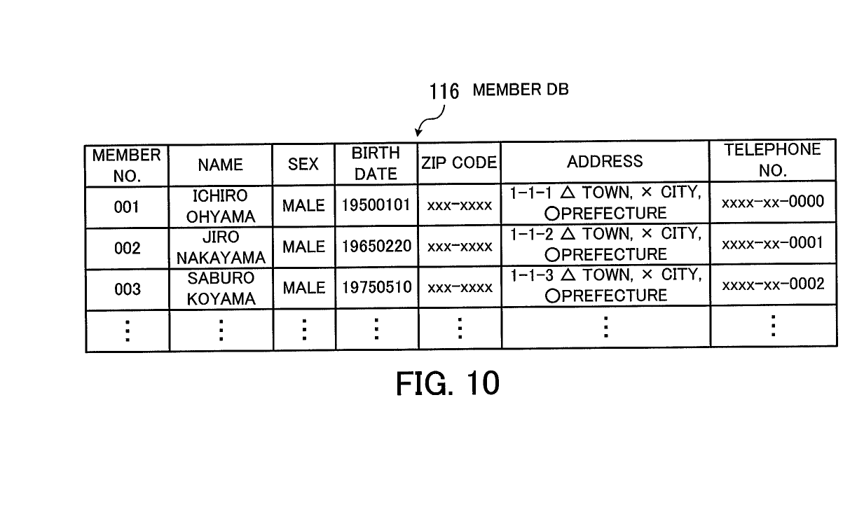

FIG. 10 illustrates an exemplary data structure of the member DB. The member DB 116 is a database in which is registered personal information about Internet users who became members to respond to questionnaires on products. The member DB 116 is provided with columns “MEMBER NO.”, “NAME”, “SEX”, “BIRTH DATE”, “ZIP CODE”, “ADDRESS”, and “TELEPHONE NO.” Items of information in each row across the columns are associated with one another and constitute a record.

The “MEMBER NO.” column has set therein the identification numbers assigned to the respective members, and the “NAME” column has set therein the names of the respective members. The “SEX” column has set therein the sexes of the respective members, and the “BIRTH DATE” column has set therein the dates of birth of the respective members. The “ZIP CODE” column has set therein the zip codes of the addresses of the respective members, and the “ADDRESS” column has set therein the addresses of the respective members. The “TELEPHONE NO.” column has set therein the telephone numbers of the respective members.

For example, for the member with the member number “001”, “ICHIRO OHYAMA” is set as the name, “MALE” as the sex, “Jan. 1, 1950 (19500101)” as the birth date, “xxx-xxxx” as the zip code, “1-1-1 Δ TOWN, x CITY, ∘ PREFECTURE” as the address, and “xxxx-xx-0000” as the telephone number.

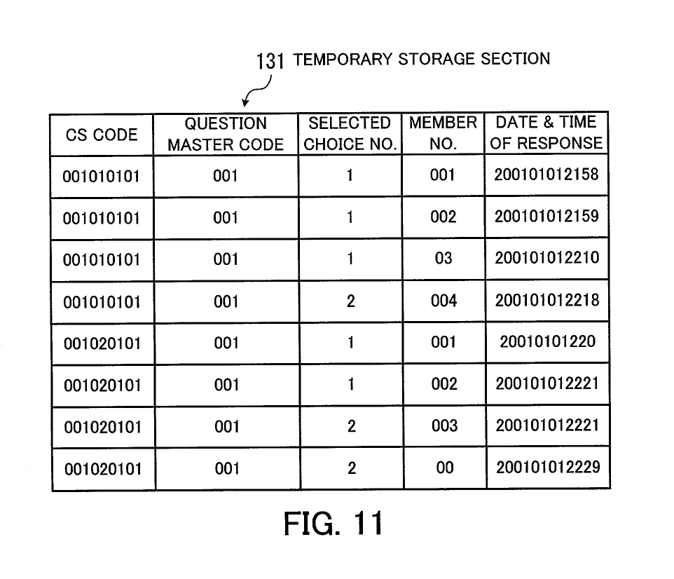

FIG. 11 illustrates an exemplary data structure of the temporary storage section. The temporary storage section 131 is a storage area for storing information constituting the results of questionnairing. The temporary storage section 131 is provided with columns “CS CODE”, “QUESTION MASTER CODE”, “SELECTED CHOICE NO.”, “MEMBER NO.” and “DATE & TIME OF RESPONSE”.

The “CS CODE” column has set therein the CS codes of the respective products with respect to which questionnairing is conducted, and the “QUESTION MASTER CODE” column has set therein the question master codes of the respective answered questions. The “SELECTED CHOICE NO.” column has set therein the choice numbers selected in the respective responses, and the “MEMBER NO.” column has set therein the member numbers of members who answered the respective questions. The “DATE & TIME OF RESPONSE” column has set therein the dates and times at which the respective responses were made.

For example, in reply to the question with the question master code “001” about the product with the CS code “001010101”, the member with the member number “001” selected the choice number “1” at 21:58 on Jan. 1, 2001 (date and time of response: “200101012158”).

With the questionnaire collection server 100 having the aforementioned functions and data structures, questionnaires on products provided by multiple corporations are collected from consumers. In the following, the questionnaire collection process will be described in detail. In the following description of the process, it is assumed that the customer 24 shown in FIG. 2, for example, responds to a questionnaire on the product 51 sold by the corporation 22, by using the customer terminal 41.

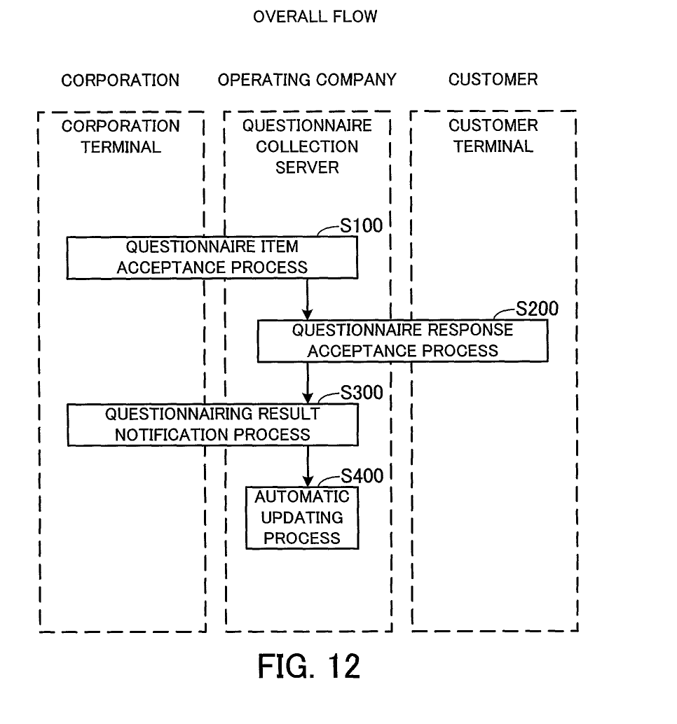

FIG. 12 is a flowchart illustrating an overall flow of the questionnaire collection process. In the following, the process shown in FIG. 12 will be explained in order of the step number.

[Step S100] A questionnaire item acceptance process is carried out between the corporation terminal 31 at the corporation 22 and the questionnaire collection server 100 at the operating company 21. The questionnaire item acceptance process is a process wherein the items of questions for questionnairing registered in advance in the questionnaire collection server 100 at the operating company 21 are displayed on the screen of the corporation terminal 31 at the corporation 22, and the questionnaire collection server 100 accepts the specified items of questions to be adopted in the questionnaire. This process is carried out cooperatively by the questionnaire collection server 100 and the corporation terminal 31 in response to an input operation on the part of the corporation terminal 31.

[Step S200] A questionnaire response acceptance process is carried out between the customer terminal 41 of the customer 24 and the questionnaire collection server 100 of the operating company 21. The questionnaire response acceptance process is a process wherein the response of the customer 24 to the questionnaire on the product 51 is collected and stored at the operating company 21. This process is carried out cooperatively by the customer terminal 41 and the questionnaire collection server 100 in response to an input operation on the part of the customer terminal 41.

[Step S300] A questionnairing result notification process is carried out between the corporation terminal 31 of the corporation 22 and the questionnaire collection server 100 of the operating company 21. The questionnairing result notification process is a process wherein the results of questionnairing on the product 51 are supplied to the corporation 22. This process is carried out cooperatively by the corporation terminal 31 and the questionnaire collection server 100 in response to an input operation on the part of the corporation terminal 31.

[Step S400] An automatic updating process is performed in the questionnaire collection server 100 of the operating company 21. The automatic updating process is a process wherein the items of questions to be adopted in the questionnaire on the product 51 are automatically updated in accordance with the status of selection of questions by other corporations.

The individual processes shown in FIG. 12 will be now described in detail.

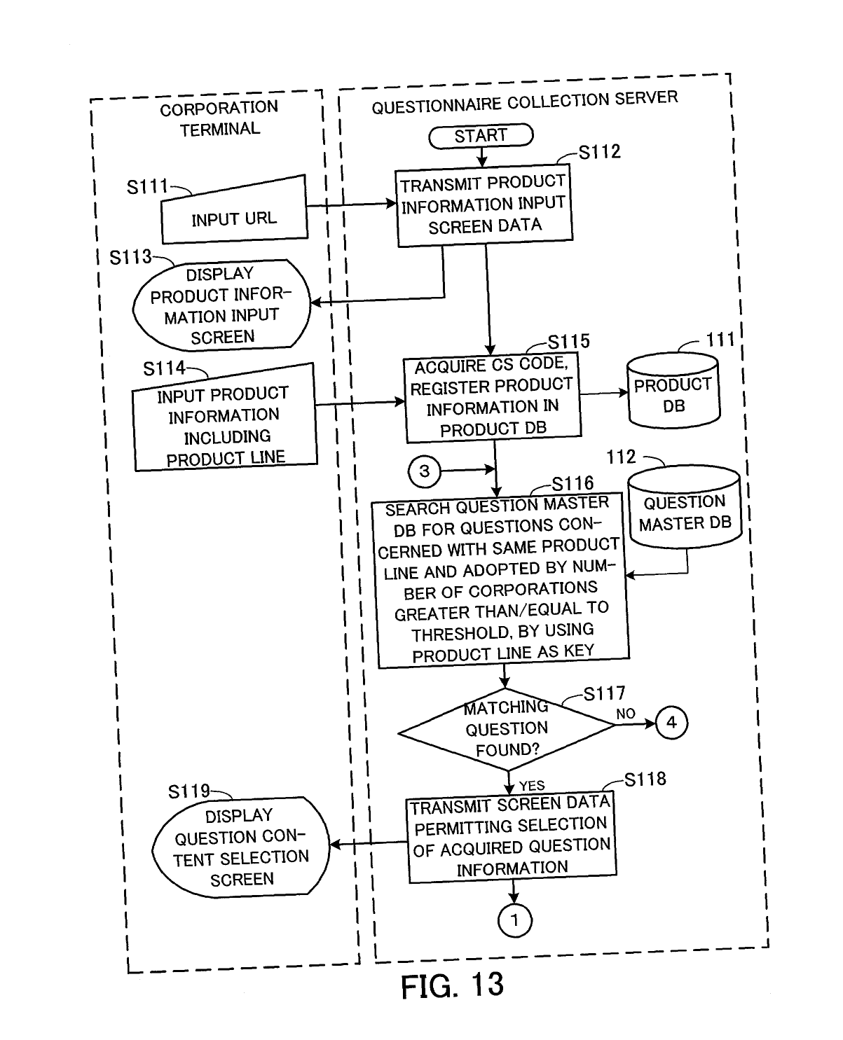

Referring first to FIGS. 13 to 16, the questionnaire item acceptance process will be described.

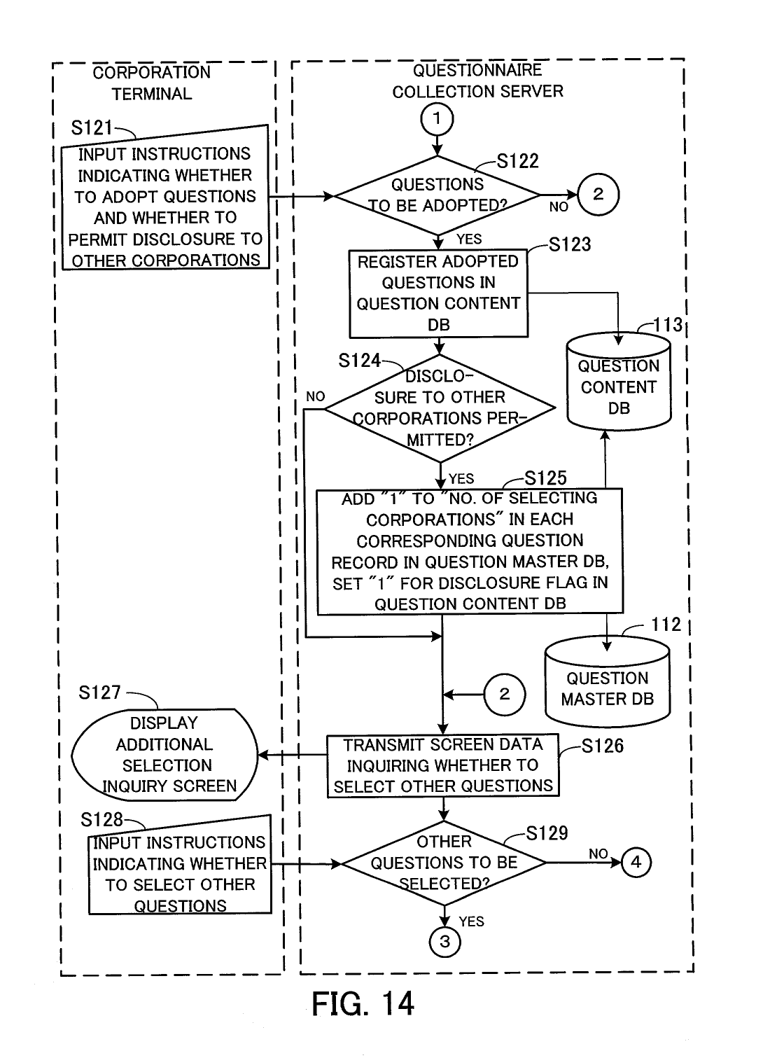

FIG. 13 is a first flowchart illustrating a procedure for the questionnaire item acceptance process. In the following, the process shown in FIG. 13 will be explained in order of the step number.

[Step S111] The corporation terminal 31 accepts the input of a URL by a staff member in charge of marketing at the corporation 22. The URL input in this case is the URL of a member-only Web site provided by the questionnaire collection server 100. The member-only Web site can be accessed only by corporations which have commissioned the operating company 21 by contract to collect questionnaires. The corporation terminal 31 sends an access request via the Internet 10 to the content in the questionnaire collection server 100 specified by the input URL.

[Step S112] On receiving the access request from the corporation terminal 31, the questionnaire content setting section 121 of the questionnaire collection server 100 at the operating company 21 transmits product information input screen data to the corporation terminal 31. The product information input screen data is, for example, data created in HTML (Hyper Text Markup Language) format.

[Step S113] Based on the product information input screen data received from the questionnaire collection server 100, the corporation terminal 31 displays a product information input screen.

[Step S114] The corporation terminal 31 accepts the input of product information by the marketing staff member at the corporation 22. The product information includes information such as the line of the product. The corporation terminal 31 transmits the input product information to the questionnaire collection server 100.

[Step S115] The questionnaire content setting section 121 of the questionnaire collection server 100 acquires a CS code for the product information received from the corporation terminal 31, and registers the product information in the product DB 111.

[Step S116] Using the product line in the registered product information as a key, the questionnaire content setting section 121 searches the question master DB 112 for questions which are concerned with the same product line and which are selected by the number of corporations larger than or equal to the threshold. The threshold used in this case is the one included in the product information registered in Step S115. The questionnaire content setting section 121 acquires information corresponding to a predetermined number of matching questions from the question master DB 112. The predetermined number is equal to the number of questions that are displayed in one screen. After acquiring information corresponding to the predetermined number of questions, the flow proceeds to the next Step S117. As Step S116 is repeatedly executed (the flow proceeds to Step S116 from Step S129 in FIG. 14), information about questions which satisfy the conditions as to the product line and the threshold is successively acquired from the question master DB 112.

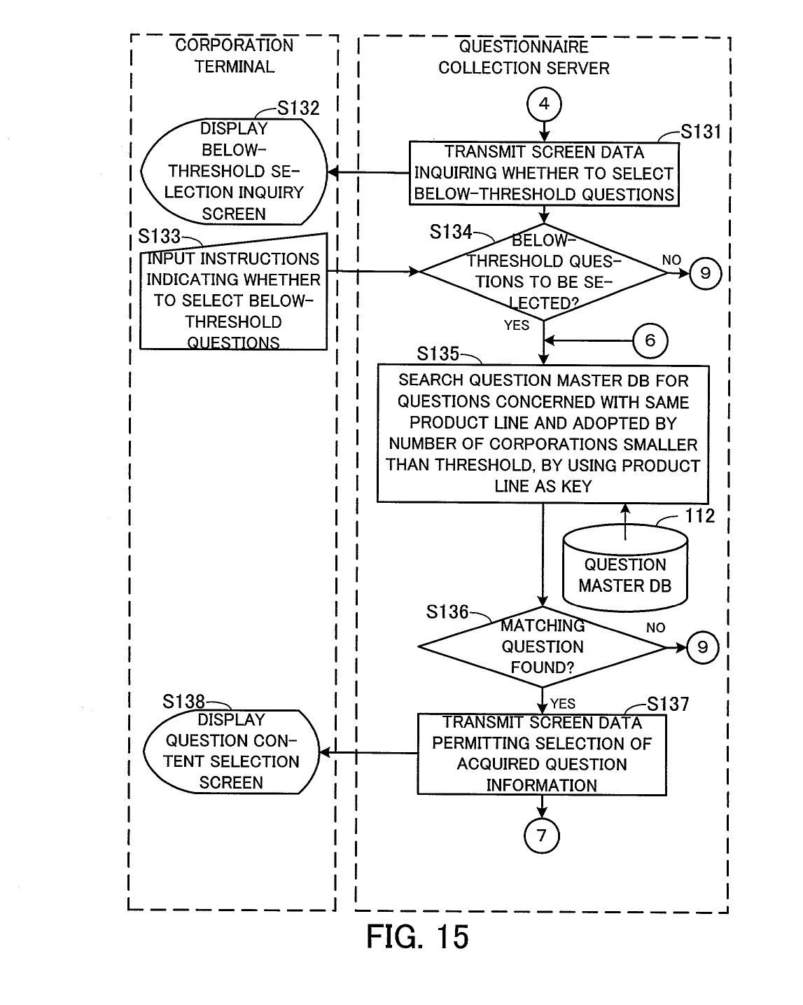

For example, in the product DB 111 shown in FIG. 5, the product line of the product with the CS code “001010101” is “PC” and the threshold is “3”. Accordingly, in the case where product information including the CS code “001010101” has been registered, the question master DB 112 is searched for questions which are concerned with the product line “PC” and of which the threshold is greater than or equal to “3”. In the example of FIG. 6, the questions with the question master codes “001”, “002” and “003” are sequentially detected.

[Step S117] The questionnaire content setting section 121 determines whether or not a matching question has been found as a result of the search in Step S116. If a matching question has been found, the flow proceeds to Step S118; if not, the flow proceeds to Step S131 in FIG. 15.

[Step S118] The questionnaire content setting section 121 transmits, to the corporation terminal 31, question content selection screen data for accepting the input of selection of the questions acquired from the question master DB 112. The process of the questionnaire collection server 100 then proceeds to Step S122 in FIG. 14.

[Step S119] Based on the question content selection screen data received from the questionnaire collection server 100, the corporation terminal 31 displays a question content selection screen.

FIG. 14 is a second flowchart illustrating the procedure for the questionnaire item acceptance process. In the following, the process shown in FIG. 14 will be explained in order of the step number.

[Step S121] The corporation terminal 31 at the corporation 22 accepts an input instructing whether to adopt the questions and whether to permit the disclosure to other corporations. Then, the corporation terminal 31 transmits the input instructions to the questionnaire collection server 100 at the operating company 21.

[Step S122] The questionnaire content setting section 121 of the questionnaire collection server 100 interprets the instructions received from the corporation terminal 31 and determines whether or not the acquired questions should be adopted. If the instructions are to adopt the questions, the flow proceeds to Step S123; if not, the flow proceeds to Step S126.

[Step S123] The questionnaire content setting section 121 registers the question master codes of the adopted questions in the question content DB 113 in a manner associated with the CS code of the product which is the subject of questionnairing. At this time, “0” is set as an initial state of the disclosure flag, and also “0” is set for the ignore threshold flag.

[Step S124] The questionnaire content setting section 121 determines based on the instructions from the corporation terminal 31 whether or not the disclosure to other corporations is permitted. If the disclosure to other corporations is permitted, the flow proceeds to Step S125; if not, the flow proceeds to Step S126.

[Step S125] The questionnaire content setting section 121 adds “1” to the number of selecting corporations in each of the corresponding question records in the question master DB 112. Also, the questionnaire content setting section 121 sets “1” for the disclosure flag associated with each of the corresponding questions in the question content DB 113.

[Step S126] The questionnaire content setting section 121 transmits, to the corporation terminal 31, additional selection inquiry screen data for inquiring whether other questions are to be selected.

[Step S127] Based on the additional selection inquiry screen data received from the questionnaire collection server 100, the corporation terminal 31 displays an additional selection inquiry screen.

[Step S128] The corporation terminal 31 accepts an input instructing whether to select other questions. Then, the corporation terminal 31 transmits the input instructions to the questionnaire collection server 100.

[Step S129] The questionnaire content setting section 121 of the questionnaire collection server 100 determines based on the instructions from the corporation terminal 31 whether or not other questions should be selected. If the instructions are to select other questions, the flow proceeds to Step S116 in FIG. 13; if not, the flow proceeds to Step S131 in FIG. 15.

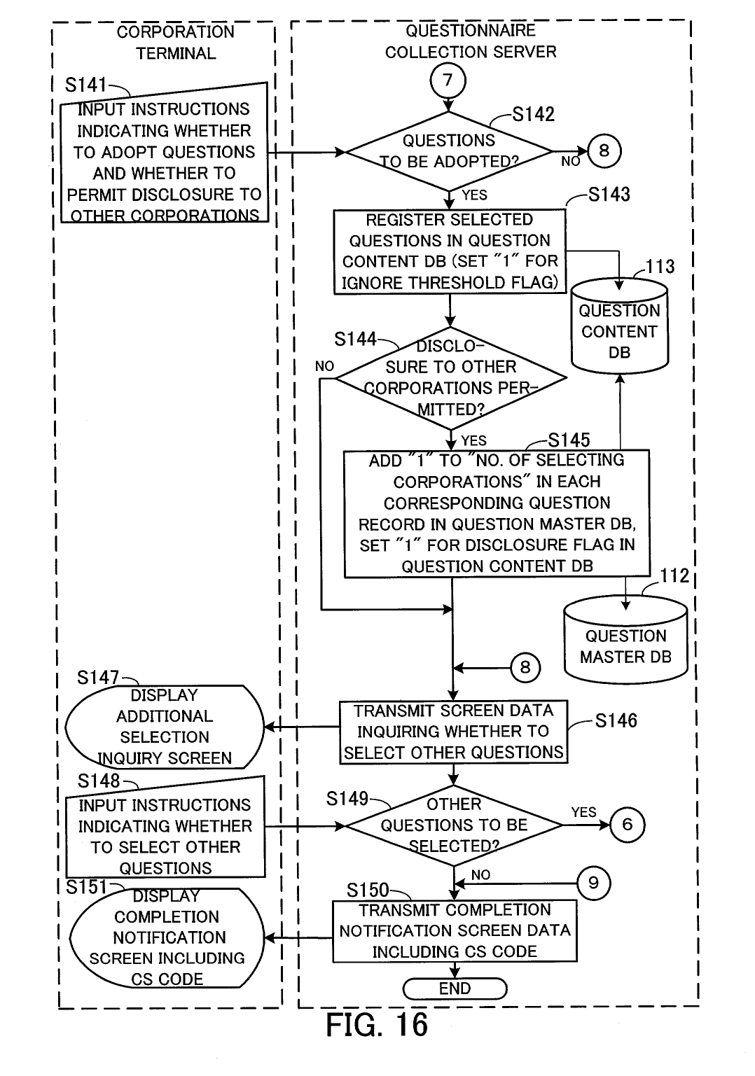

FIG. 15 is a third flowchart illustrating the procedure for the questionnaire item acceptance process. In the following, the process shown in FIG. 15 will be explained in order of the step number.

[Step S131] The questionnaire content setting section 121 of the questionnaire collection server 100 transmits, to the corporation terminal 31, screen data (below-threshold selection inquiry screen data) for inquiring whether questions below the threshold are to be selected.

[Step S132] Based on the below-threshold selection inquiry screen data received from the questionnaire collection server 100, the corporation terminal 31 displays a below-threshold selection inquiry screen.

[Step S133] The corporation terminal 31 accepts an input instructing whether to select questions below the threshold. Then, the corporation terminal 31 notifies the questionnaire collection server 100 of the input instructions.

[Step S134] The questionnaire content setting section 121 of the questionnaire collection server 100 determines based on the instructions from the corporation terminal 31 whether or not below-threshold questions should be selected. If below-threshold questions should be selected, the flow proceeds to Step S135; if not, the flow proceeds to Step S150 in FIG. 16.

[Step S135] Using the product line as a search key, the questionnaire content setting section 121 searches the question master DB 112 for questions which are adopted by the number of corporations smaller than the threshold among those concerned with the same product line. Then, the questionnaire content setting section 121 acquires, from the question master DB 112, information corresponding to the predetermined number (the number of questions displayed in one screen) of matching questions. After acquiring the information corresponding to the predetermined number of questions, the flow proceeds to the next Step S136. As Step S135 is repeatedly executed (the flow proceeds to Step S135 from Step S149 in FIG. 16), information about questions which satisfy the conditions as to the product line and the threshold is successively acquired from the question master DB 112.

[Step S136] The questionnaire content setting section 121 determines whether or not a matching question has been found as a result of the search in Step S135. If a matching question has been found, the flow proceeds to Step S137; if not, the flow proceeds to Step S150 in FIG. 16.

[Step S137] The questionnaire content setting section 121 transmits, to the corporation terminal 31, the question content selection screen data for accepting the input of selection of the questions acquired from the question master DB 112. The process of the questionnaire collection server 100 then proceeds to Step S141 in FIG. 16.

[Step S138] Based on the question content selection screen data received from the questionnaire collection server 100, the corporation terminal 31 displays the question content selection screen.

FIG. 16 is a fourth flowchart illustrating the procedure for the questionnaire item acceptance process. In the following, the process shown in FIG. 16 will be explained in order of the step number.

[Step S141] The corporation terminal 31 at the corporation 22 accepts an input instructing whether to adopt the questions and whether to permit the disclosure to other corporations. Then, the corporation terminal 31 transmits the input instructions to the questionnaire collection server 100 at the operating company 21.

[Step S142] The questionnaire content setting section 121 of the questionnaire collection server 100 interprets the instructions received from the corporation terminal 31, to determine whether or not the acquired questions should be adopted. If the instructions are to adopt the questions, the flow proceeds to Step S143; if not, the flow proceeds to Step S146.

[Step S143] The questionnaire content setting section 121 registers the question master codes of the adopted questions in the question content DB 113 in a manner associated with the CS code of the product which is the subject of questionnairing. At this time, “0” is set as the initial state of the disclosure flag, and “1” is set for the ignore threshold flag.

[Step S144] The questionnaire content setting section 121 determines based on the instructions from the corporation terminal 31 whether or not the disclosure to other corporations is permitted. If the disclosure to other corporations is permitted, the flow proceeds to Step S145; if not, the flow proceeds to Step S146.

[Step S145] The questionnaire content setting section 121 adds “1” to the number of selecting corporations in each of the corresponding question records in the question master DB 112. Also, the questionnaire content setting section 121 sets “1” for the disclosure flag associated with each of the corresponding questions in the question content DB 113.

[Step S146] The questionnaire content setting section 121 transmits, to the corporation terminal 31, the additional selection inquiry screen data for inquiring whether other questions are to be selected.

[Step S147] Based on the additional selection inquiry screen data received from the questionnaire collection server 100, the corporation terminal 31 displays the additional selection inquiry screen.

[Step S148] The corporation terminal 31 accepts an input instructing whether to select other questions. Then, the corporation terminal 31 transmits the input instructions to the questionnaire collection server 100.

[Step S149] The questionnaire content setting section 121 of the questionnaire collection server 100 determines based on the instructions from the corporation terminal 31 whether or not other questions should be selected. If the instructions are to select other questions, the flow proceeds to Step S135 in FIG. 15; if not, the flow proceeds to Step S150.

[Step S150] The questionnaire content setting section 121 transmits, to the corporation terminal 31, completion notification screen data including the CS code acquired in Step S115.

[Step S151] The corporation terminal 31 displays a completion notification screen including the CS code.

In this manner, the contents of questions to be adopted in the questionnaire on the product 51 sold by the corporation 22 can be registered in the questionnaire collection server 100 in accordance with input operations of the corporation terminal 31. In this case, the corporation 22 can determine whether to adopt questions or not in accordance with the number of corporations which have adopted the respective questions and which have permitted the disclosure to other corporations, and this enables the corporation to adopt only those questions which are useful for comparison with the results of questionnairing on other corporations' products.

Examples of screens displayed at the corporation terminal 31 during the questionnaire item acceptance process will be now described.

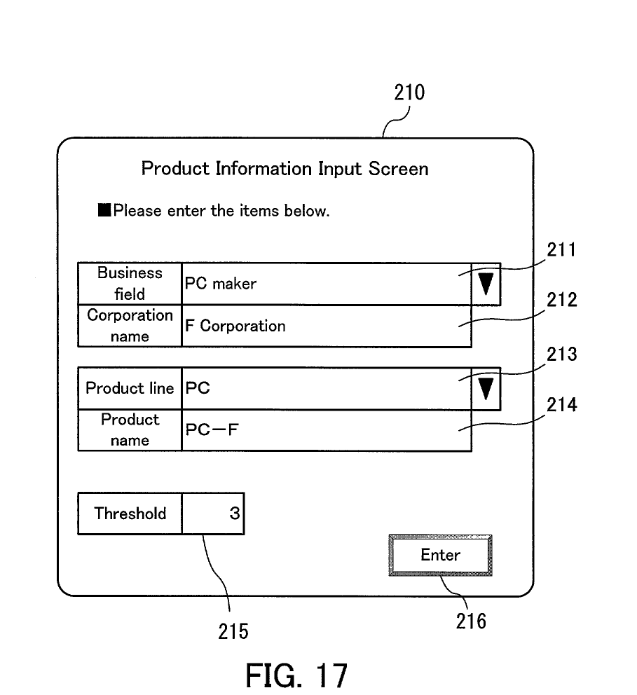

FIG. 17 shows an example of the product information input screen. The product information input screen 210 includes a business field input area 211, a corporation name input area 212, a product line input area 213, a product name input area 214, a threshold input area 215, and an enter button 216.

The business field input area 211 is a textbox in which is input the industry type (business field) of the corporation 22 requesting the operating company 21 to collect questionnaires on the product. The business field may be selected from the pull-down menu.

The corporation name input area 212 also is a textbox in which is input the name of the corporation 22 requesting the operating company 21 to collect questionnaires on the product.

The product line input area 213 is a textbox in which is input the type (product line) of the product which is the subject of questionnairing. The product line may be selected from the pull-down menu.

The product name input area 214 is a textbox in which is input the name (model name) of the product as the subject of questionnairing.

The threshold input area 215 also is a textbox in which is specified the number of corporations (threshold) serving as a criterion for selecting questions to be adopted in the questionnaire. Those questions which are adopted by the number of corporations greater than or equal to the number specified as the threshold are preferentially extracted as suggested questions.

The enter button 216 is used to confirm the contents input in the product information input screen 210 and to transmit the input information to the questionnaire collection server 100. When the enter button 216 is pressed, the information input in the product information input screen 210 is transmitted to the questionnaire collection server 100.

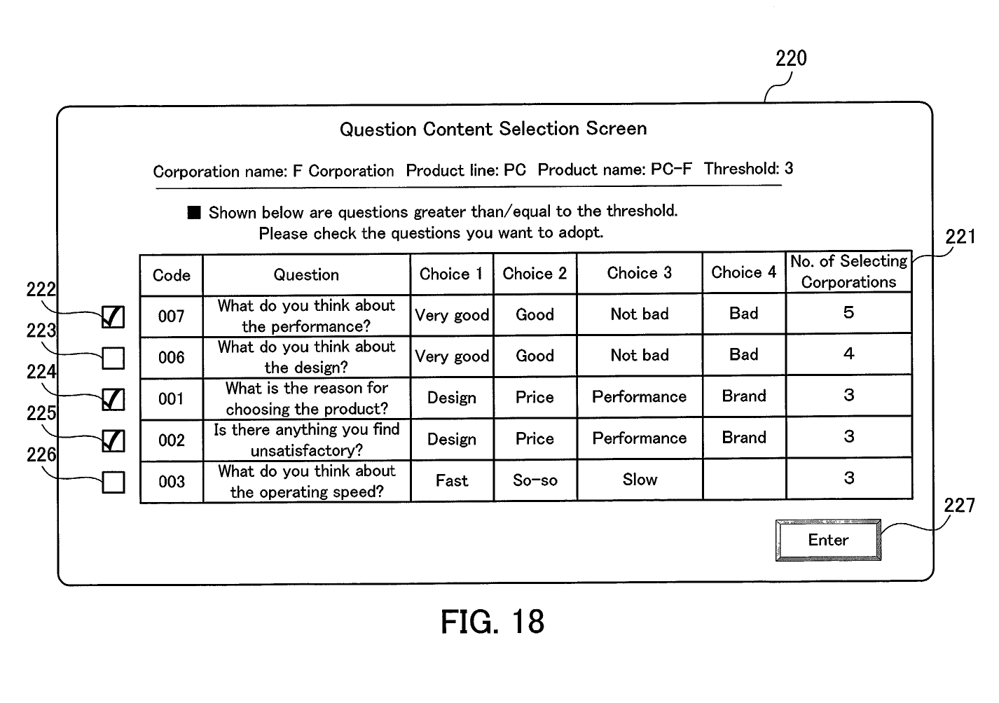

FIG. 18 shows an example of the question content selection screen. The question content selection screen 220 includes a suggested question display area 221, checkboxes 222 to 226, and an enter button 227.

In the suggested question display area 221, information about the questions retrieved by the questionnaire collection server 100 is displayed. In the example of FIG. 18, the suggested question display area 221 is provided therein with columns “Code”, “Question”, “Choice 1”, “Choice 2”, “Choice 3”, “Choice 4”, and “No. of Selecting Corporations”. In the “Code” column are displayed the question master codes of respective questions. In the “Question” column, character strings indicating the contents of the respective questions are displayed. In the “Choice 1” column are displayed character strings indicating the contents of first choices responsive to the respective questions, and in the “Choice 2” column are displayed character strings indicating the contents of second choices responsive to the respective questions. In the “Choice 3” column are displayed character strings indicating the contents of third choices responsive to the respective questions, and in the “Choice 4” column are displayed character strings indicating the contents of fourth choices responsive to the respective questions. In the “No. of Selecting Corporations” column, the numbers of corporations which have adopted the respective questions in their questionnaires are displayed.

The checkboxes 222 to 226 are arranged such that one checkbox is associated with each of the questions displayed in the suggested question display area 221. When the checkboxes 222 to 226 are selected, checkmarks are displayed inside the respective checkboxes 222 to 226. In the example of FIG. 18, the checkboxes 222, 224 and 225 are selected. The questions corresponding to the selected checkboxes 222, 224 and 225 are adopted in the questionnaire.

The enter button 227 is used to confirm the selection of questions and to transmit information about the selected questions to the questionnaire collection server 100. When the enter button 227 is pressed, information (e.g. question master codes) identifying the selected questions is transmitted to the questionnaire collection server 100.

Thus, by manipulating the corporation terminal 31, a marketing staff member at the corporation 22 can register the contents of the questionnaire on the product 51 in the questionnaire collection server 100 at the operating company 21.

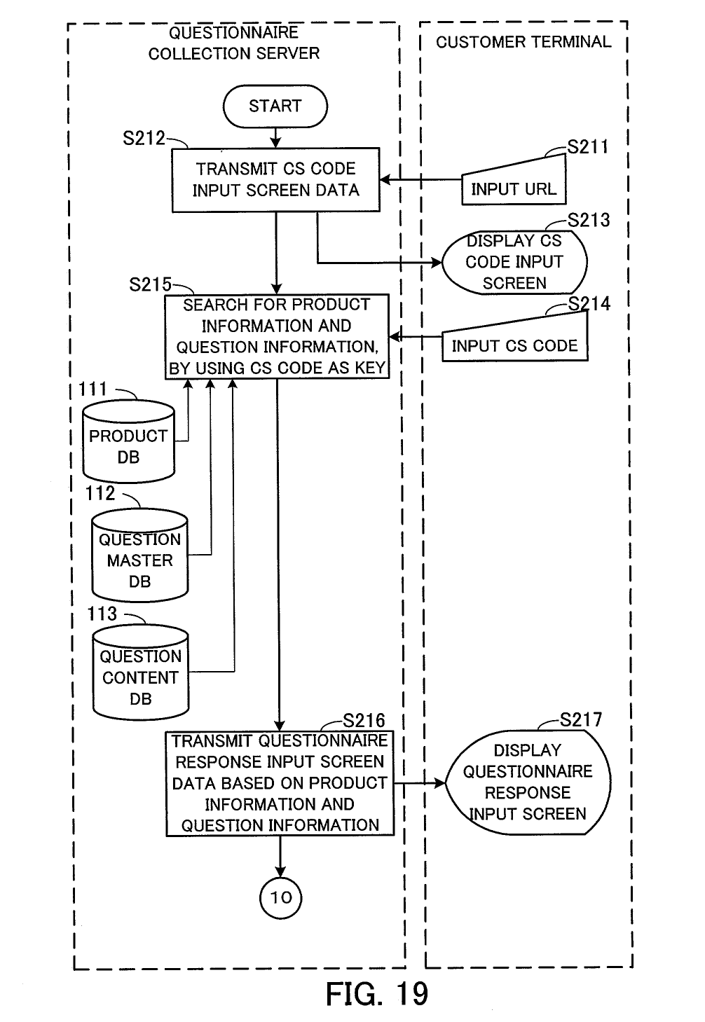

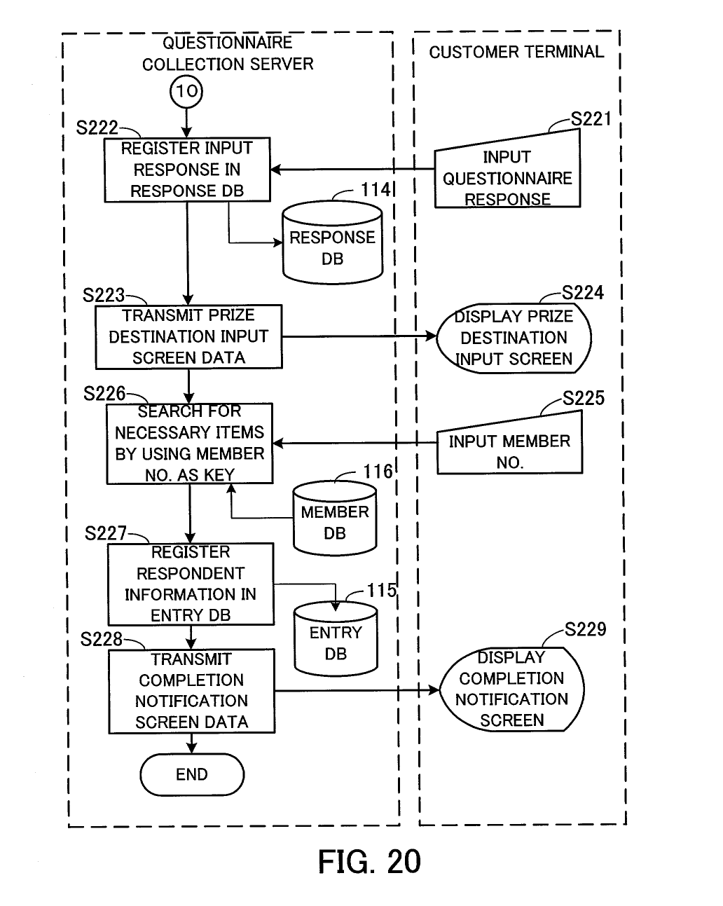

Referring now to FIGS. 19 and 20, the process of accepting questionnaire responses from customers will be described in detail.

FIG. 19 is a first flowchart illustrating a procedure for the questionnaire response acceptance process. In the following, the process shown in FIG. 19 will be explained in order of the step number.

[Step S211] The customer terminal 41 used by the customer 24 accepts the input of a URL (address of a questionnaire response input page) by the customer 24. The customer 24 inputs the URL of the questionnaire collection server 100 to the customer terminal 41, whereupon the customer terminal 41 accesses the questionnaire response input page in the questionnaire collection server 100.

[Step S212] In response to the access request from the customer terminal 41, the questionnaire response collecting section 122 of the questionnaire collection server 100 at the operating company 21 transmits CS code input screen data to the customer terminal 41.

[Step S213] Based on the CS code input screen data received from the questionnaire collection server 100, the customer terminal 41 displays a CS code input screen.

[Step S214] The customer terminal 41 accepts the input of a CS code by the customer 24. Upon input of a CS code by the customer 24, the customer terminal 41 notifies the questionnaire collection server 100 of the input CS code. The customer 24 can find the CS code of the product 51 he/she purchased, by referring to the material attached to the product 51.

[Step S215] Using the CS code received from the customer terminal 41 as a key, the questionnaire response collecting section 122 of the questionnaire collection server 100 searches the product DB 111, the question master DB 112 and the question content DB 113 for product information and question information.

[Step S216] The questionnaire response collecting section 122 generates questionnaire response input screen data based on the product information and the question information, and transmits the generated data to the customer terminal 41. Then, the process of the questionnaire collection server 100 proceeds to Step S222 in FIG. 20.

[Step S217] Based on the questionnaire response input screen data received from the questionnaire collection server 100, the customer terminal 41 displays a questionnaire response input screen.

FIG. 20 is a second flowchart illustrating the procedure for the questionnaire response acceptance process. In the following, the process shown in FIG. 20 will be explained in order of the step number.

[Step S221] The customer terminal 41 accepts the input of a questionnaire response by the customer 24. Then, the customer terminal 41 transmits the questionnaire response input by the customer 24 to the questionnaire collection server 100.

[Step S222] The questionnaire response collecting section 122 of the questionnaire collection server 100 registers the contents of the questionnaire response received from the customer terminal 41 in the response DB 114.

[Step S223] The questionnaire response collecting section 122 transmits prize destination input screen data to the customer terminal 41.

[Step S224] Based on the prize destination input screen data received from the questionnaire collection server 100, the customer terminal 41 displays a prize destination input screen.

[Step S225] The customer terminal 41 accepts the input of the member number by the customer 24. Upon input of the member number, the customer terminal 41 transmits the input member number to the questionnaire collection server 100.

[Step S226] Using the member number received from the customer terminal 41 as a key, the questionnaire response collecting section 122 searches the member DB 116 for necessary items of member information.

[Step S227] The questionnaire response collecting section 122 registers the member number in the entry DB 115 in a manner associated with the entry date and the CS code.

[Step S228] The questionnaire response collecting section 122 generates completion notification screen data including the member information extracted from the member DB 116, and transmits the generated completion notification screen data to the customer terminal 41.

[Step S229] Based on the completion notification screen data received from the questionnaire collection server 100, the customer terminal 41 displays a completion notification screen.

Thus, a questionnaire response can be collected from the customer 24 and stored in the response DB 114, and also information about the customer 24 can be stored in the entry DB 115. The questionnaire response is input to the customer terminal 41 by the customer 24. In the following, examples of screens displayed at the customer terminal 41 during the questionnaire response acceptance process will be described.

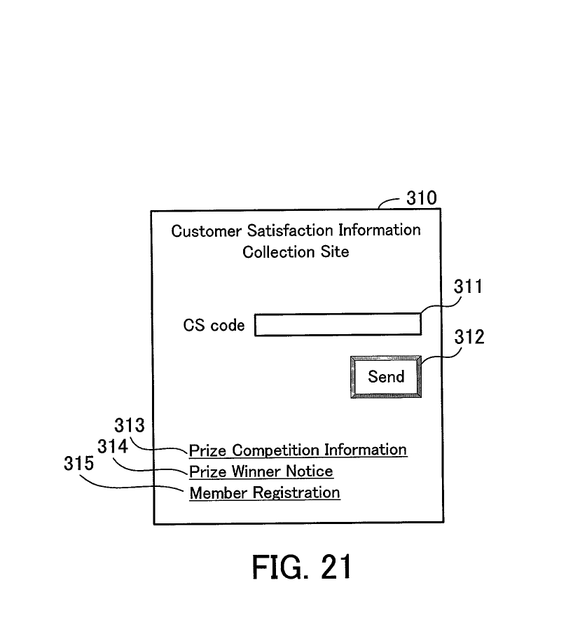

FIG. 21 shows an example of the CS code input screen. The CS code input screen 310 is a Web page within a customer satisfaction information collection site. In the CS code input screen 310 are provided a CS code input area 311, a send button 312, a link 313 to a prize competition information page, a link 314 to a prize winner notice page, and a link 315 to a member registration page.

The CS code input area 311 is a textbox in which is input the CS code of a product which is the subject of questionnairing. The send button 312 is used for transmitting the CS code input in the CS code input area 311 to the questionnaire collection server 100. The prize competition information page link 313 is an anchor display area (highlighted area showing a link to a different page) for switching the screen to a page showing prizes etc. for the prize competition in which the customer can participate by responding to the questionnaire. The prize winner notice page link 314 is an anchor display area for switching the screen to a page that announces prize winners. The member registration page link 315 is an anchor display area for switching the screen to a page for member registration.

The customer 24 inputs the CS code of the product in the CS code input area 311 and presses the send button 312, whereupon the questionnaire collection server 100 is notified of the CS code. Then, the screen of the customer terminal 41 switches to the questionnaire response input screen.

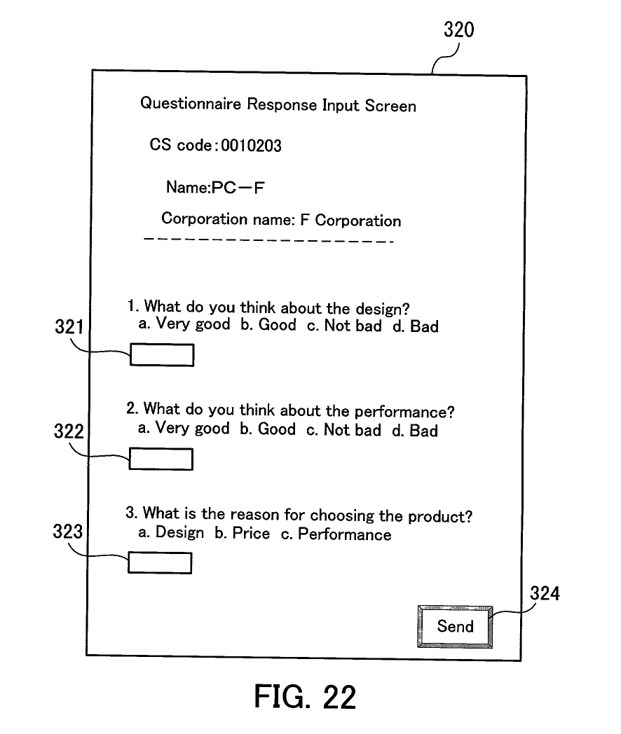

FIG. 22 shows an example of the questionnaire response input screen. The questionnaire response input screen 320 is a screen which permits the customer 24 to input answers to respective questions in the questionnaire on the product he/she has purchased. In the questionnaire response input screen 320 are displayed, besides information (CS code, name, and corporation name) about the product as the subject of questionnairing, the contents of the questions and choices responsive to the respective questions.

The questionnaire response input screen 320 is also provided with response input areas 321 to 323 for inputting responses to the respective questions, and a send button 324. The response input areas 321 to 323 are each a textbox permitting the input of a character that represents a choice. The send button 324 is used for notifying the questionnaire collection server 100 of the response to the questionnaire.

The customer 24 inputs choices for the respective questions in the response input areas 321 to 323 and presses the send button 324, whereupon the response to the questionnaire is transmitted from the customer terminal 41 to the questionnaire collection server 100. Then, the screen of the customer terminal 41 switches to the prize destination input screen.

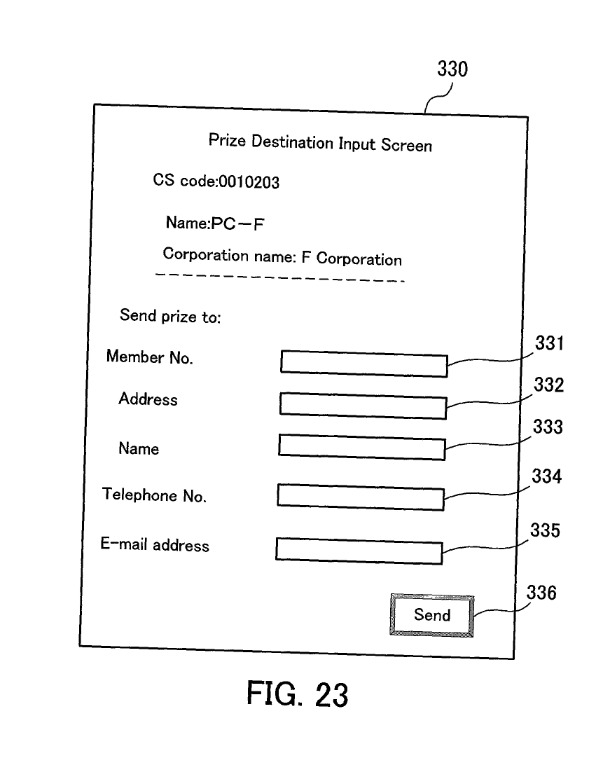

FIG. 23 shows an example of the prize destination input screen. The prize destination input screen 330 is a screen permitting the input of an address to which a prize is sent when the customer has won the prize.

In the prize destination input screen 330 are displayed, besides information (CS code, name and corporation name) about the product as the subject of questionnairing, input items for specifying the destination of the prize. The input items include a member number input area 331, an address input area 332, a name input area 333, a telephone number input area 334, and an electronic mail address input area 335.

The member number input area 331 is a textbox in which is input the member number of the customer 24. The address input area 332 is a textbox in which is input the address of the customer 24, and the name input area 333 is a textbox in which is input the name of the customer 24. The telephone number input area 334 is a textbox in which is input the telephone number of the customer 24, and the electronic mail address input area 335 is a textbox in which is input the electronic mail address of the customer 24. If the member information is the same as that already registered, data entry in the input items except the member number may be omitted.

The prize destination input screen 330 is also provided with a send button 336. The send button 336 is used for notifying the questionnaire collection server 100 of the information input in the respective input items.

The customer 24 inputs personal information in the individual input items and presses the send button 336, whereupon the input information is transmitted to the questionnaire collection server 100. Then, the screen of the customer terminal 41 switches to the completion notification screen.

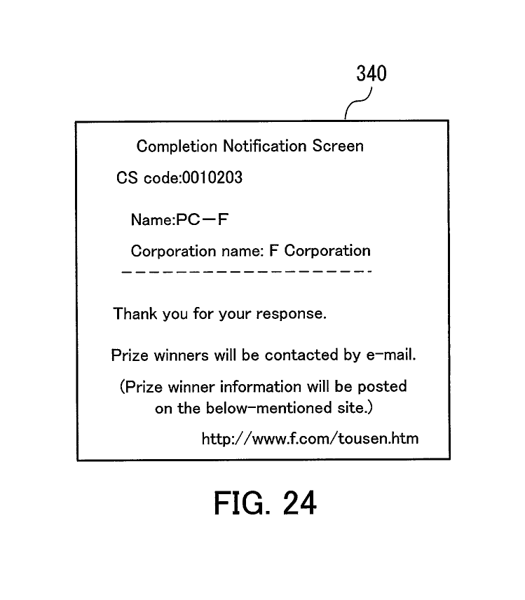

FIG. 24 shows an example of the completion notification screen. In the completion notification screen 340 are displayed information about the product as the subject of questionnairing, a message of gratitude for responding to the questionnaire, a method of notification of prize winners, etc.

Thus, the questionnaire response from the customer 24 can be accepted and stored in the questionnaire collection server 100, and also the customer 24 can be added as a participant in the prize competition.

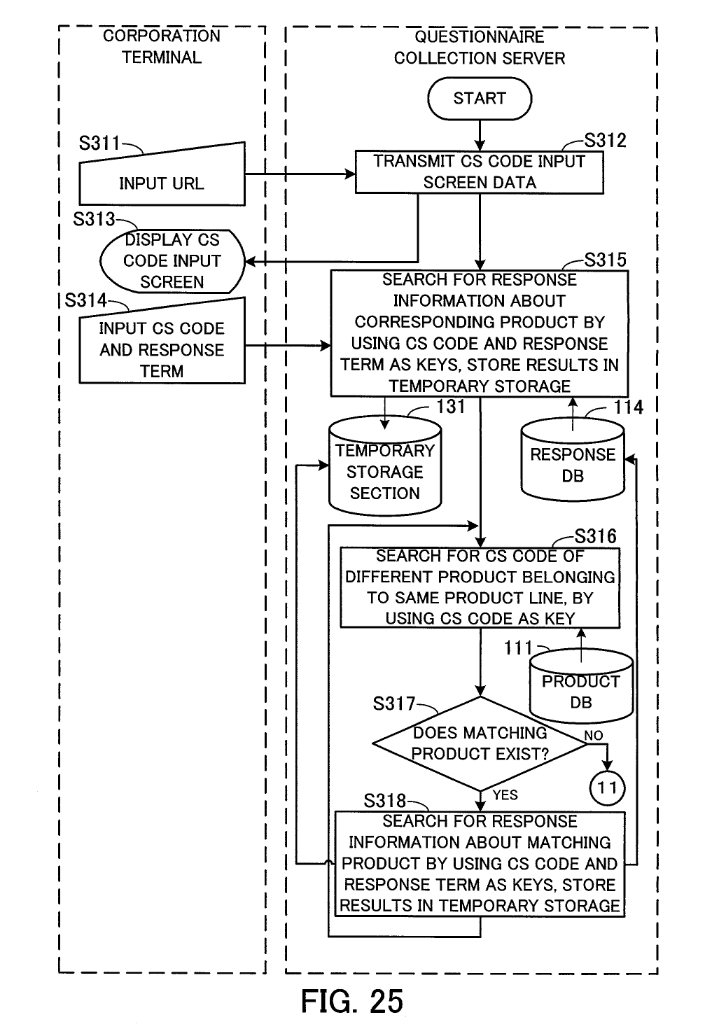

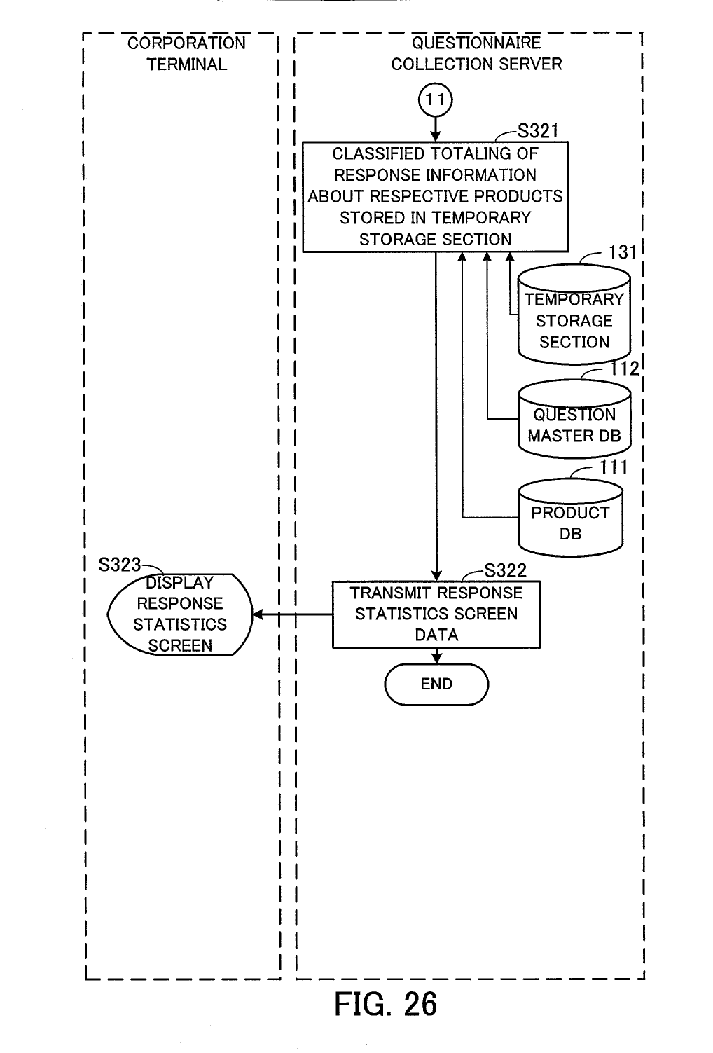

Referring now to FIGS. 25 and 26, the questionnairing result notification process will be described in detail.

FIG. 25 is a first flowchart illustrating a procedure for the questionnairing result notification process. In the following, the process shown in FIG. 25 will be explained in order of the step number.

[Step S311] The corporation terminal 31 at the corporation 22 accepts the input of a URL. The URL input in this case is the address of a page by means of which the questionnaire collection server 100 notifies the results of questionnairing. Upon input of the URL, the corporation terminal 31 transmits, to the questionnaire collection server 100, a request for access to the page corresponding to the URL.

[Step S312] The questionnairing result notifying section 123 of the questionnaire collection server 100 at the operating company transmits CS code input screen data to the corporation terminal 31.

[Step S313] Based on the CS code input screen data received from the questionnaire collection server 100, the corporation terminal 31 displays a CS code input screen.

[Step S314] The corporation terminal 31 accepts the input of a CS code and a response term. Upon input of a CS code and a response term, the corporation terminal 31 transmits the input information to the questionnaire collection server 100.

[Step S315] Using the CS code and the response term as keys, the questionnairing result notifying section 123 of the questionnaire collection server 100 searches the response DB 114 for response information about the product matching the keys. Then, the questionnairing result notifying section 123 temporarily stores the search results in the temporary storage section 131.

[Step S316] Using the CS code as a key, the questionnairing result notifying section 123 searches the product DB 111 for the CS code of a different product belonging to the same line as the product in question.

[Step S317] The questionnairing result notifying section 123 determines whether or not a matching product has been found in Step S316. If a matching product has been found, the flow proceeds to Step S318; if not, the flow proceeds to Step S321 in FIG. 26.

[Step S318] Using the CS code of the product detected in Step S316 and the response term notified from the corporation terminal 31 as keys, the questionnairing result notifying section 123 searches the response DB 114. Then, the questionnairing result notifying section 123 temporarily stores the search results in the temporary storage section 131.

FIG. 26 is a second flowchart illustrating the procedure for the questionnairing result notification process. In the following, the process shown in FIG. 26 will be explained in order of the step number.

[Step S321] The questionnairing result notifying section 123 performs classified totaling of the response information about the respective products stored in the temporary storage section 131, and extracts related information from the product DB 111 and the question master DB 112.

[Step S322] The questionnairing result notifying section 123 generates response statistics screen data based on the response information obtained by the classified totaling in Step S321 and various other response-related information. Then, the questionnairing result notifying section 123 transmits the response statistics screen data to the corporation terminal 31.

[Step S323] Based on the response statistics screen data received from the questionnaire collection server 100, the corporation terminal 31 at the corporation 22 displays a response statistics screen. The response statistics screen shows the results of responses to questions about the product corresponding to the CS code specified by the corporation terminal 31, in comparison with the results of responses to the same questions about the products of the same line sold by different corporations.

Thus, the corporation terminal 31 can display the results of responses to questions about the corporation's product in comparison with the results of responses to the same questions about other corporations' products.

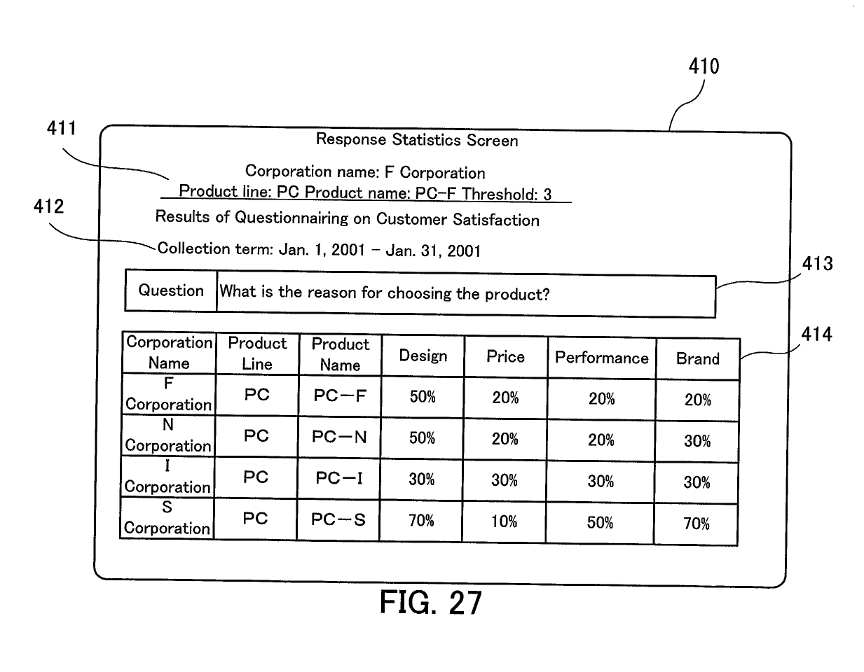

FIG. 27 shows an example of the response statistics screen. In the response statistics screen 410 are displayed results of questionnairing on a plurality of products provided by multiple corporations in a manner such that the results can be compared with one another. The response statistics screen 410 includes a totaling condition display area 411, a response collection term display area 412, a question display area 413, and a response display area 414.

In the totaling condition display area 411 are displayed totaling conditions under which the classified totaling of responses was performed. For example, the corporation name, the product line, the product name, the threshold, etc. are displayed. In the response collection term display area 412 is displayed the term with respect to which the responses were collected. In the question display area 413 is displayed the question with respect to which the responses were totaled, and in the response display area 414 are displayed the results of classified totaling of the responses to the same question about the respective products.

In the example of FIG. 27, the results of classified totaling of responses to the question “What is the reason for choosing the product?” are displayed. This question allows multiple responses or answers.

The response display area 414 is provided with columns “Corporation Name”, “Product Line”, “Product Name”, “Design”, “Price”, “Performance” and “Brand”. The columns “Design”, “Price”, “Performance” and “Brand” correspond to the respective choices for answering the question, and are set in accordance with the question displayed. In the “Corporation Name” column are displayed the names of corporations manufacturing or selling the respective products. In the “Product Line” column are displayed the types of the respective products, and in the “Product Name” column are displayed the names of the respective products. In the columns “Design”, “Price”, “Performance” and “Brand” corresponding to the respective choices for answering the question, the rates of selection of the individual choices are shown in percentage.

Thus, the corporation can compare the results of questionnairing on its product with the results of questionnairing on competing products of other corporations. Such comparison of questionnairing results enables the corporation to make a more objective judgment on the consumers' evaluation of its products, for example.

In the example of FIG. 27, for example, the greatest number (50%) of customers selected the choice “Design” as the reason for choosing the PC “PC-F” of F Corporation. The responses to the questionnaires on the other corporations' products also reveal that many customers selected the choice “Design” as the reason for choosing the products. This indicates that consumers tend to think much of design when choosing products.

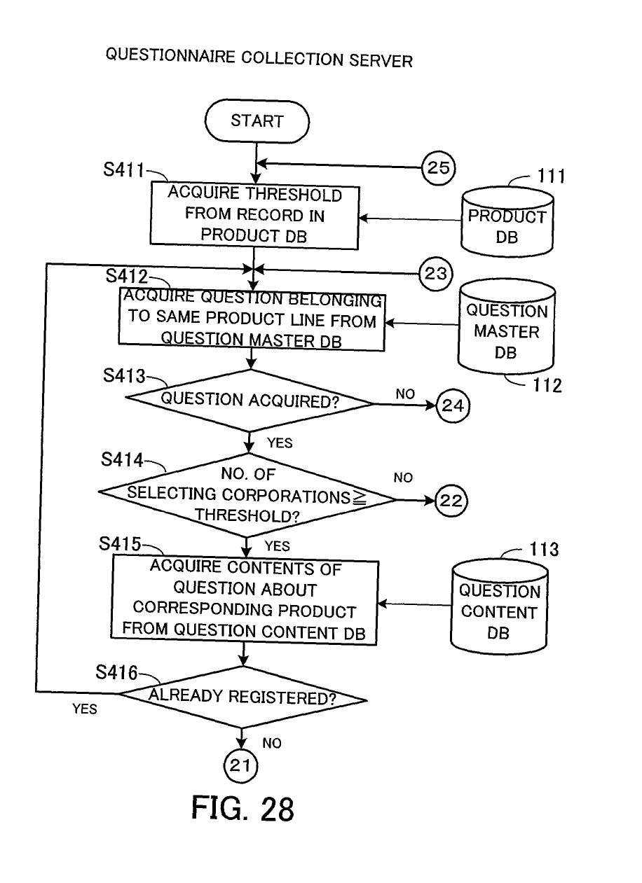

Referring now to FIGS. 28 to 30, the process of automatically updating the questions adopted in the questionnaires will be described in detail.

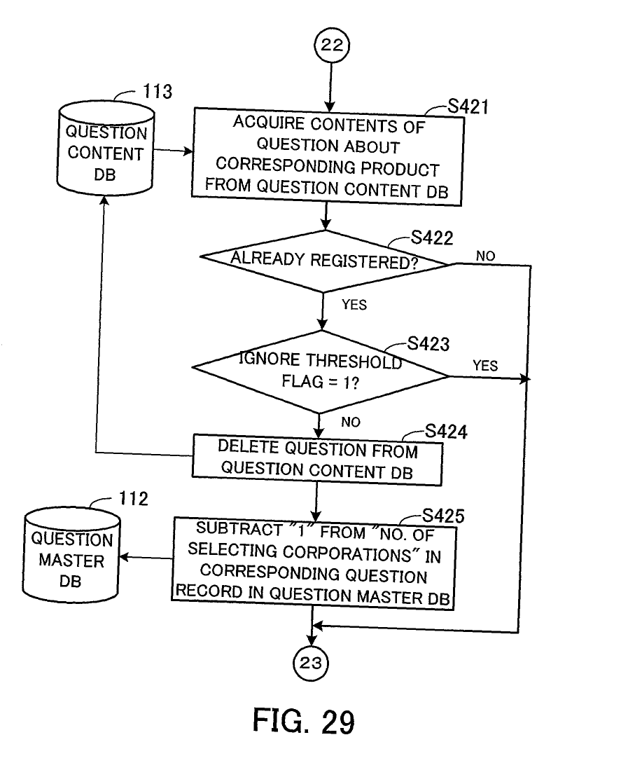

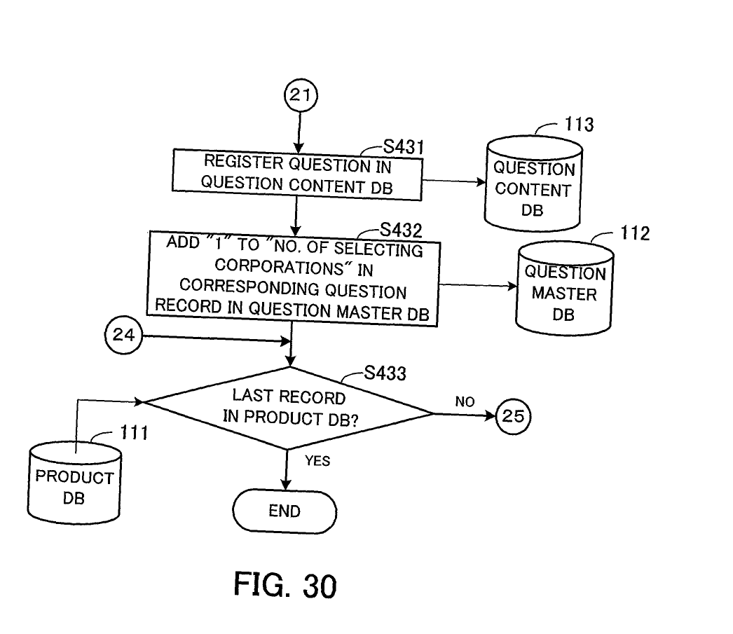

FIG. 28 is a first flowchart illustrating a procedure for the automatic updating process. In the following, the process shown in FIG. 28 will be explained in order of the step number. The automatic updating process is executed periodically at predetermined intervals of time with respect to each product, for example.

[Step S411] The automatic data updating section 124 of the questionnaire collection server 100 looks up the records of the product DB 111 from the head one to specify an automatic updating product, which is the subject of updating, and acquires the threshold of the automatic updating product.

[Step S412] The automatic data updating section 124 acquires, from the question master DB 112, a question belonging to the same product line as that of the product which is the subject of questionnairing.

[Step S413] The automatic data updating section 124 determines whether or not a question has been acquired in Step S412. If a question has been acquired, the flow proceeds to Step S414; if not, the flow proceeds to Step S433 in FIG. 30.

[Step S414] The automatic data updating section 124 determines whether or not the acquired question has been selected by a number of corporations greater than or equal to the threshold acquired in Step S411. If the number of selecting corporations is greater than or equal to the threshold, the flow proceeds to Step S415; if the former is smaller than the latter, the flow proceeds to Step S421 in FIG. 29.

[Step S415] The automatic data updating section 124 acquires, from the question content DB 113, the contents of the question about the automatic updating product.

[Step S416] The automatic data updating section 124 determines whether or not the question acquired in Step S412 is already registered as a question about the automatic updating product. If the question is already registered, the flow proceeds to Step S412; if not, the flow proceeds to Step S431 in FIG. 30.

FIG. 29 is a second flowchart illustrating the procedure for the automatic updating process. In the following, the process shown in FIG. 29 will be explained in order of the step number.

[Step S421] The automatic data updating section 124 acquires, from the question content DB 113, the contents of the question about the product as the subject of questionnairing.

[Step S422] The automatic data updating section 124 determines whether or not the question acquired in Step S412 is already registered as a question about the automatic updating product. If the question is already registered, the flow proceeds to Step S423; if not, the flow proceeds to Step S412 in FIG. 28.

[Step S423] The automatic data updating section 124 determines whether or not the ignore threshold flag set for the product as the subject of questionnairing is “1” (indicating that the threshold should be ignored). If the ignore threshold flag is “1”, the flow proceeds to Step S412; if the ignore threshold flag is “0”, the flow proceeds to Step S424.

[Step S424] The automatic data updating section 124 deletes from the question content DB 113 the question acquired in Step S412.

[Step S425] The automatic data updating section 124 subtracts “1” from the number of selecting corporations stored in the question master DB 112 in association with the question acquired in Step S412. The flow then proceeds to Step S412 in FIG. 28.

FIG. 30 is a third flowchart illustrating the procedure for the automatic updating process. In the following, the process shown in FIG. 30 will be explained in order of the step number.

[Step S431] The automatic data updating section 124 registers, in the question content DB 113, the question acquired in Step S412.

[Step S432] The automatic data updating section 124 adds “1” to the number of selecting corporations stored in the question master DB 112 in association with the question acquired in Step S412.

[Step S433] The automatic data updating section 124 determines whether or not the automatic updating product on which the automatic updating process is being performed corresponds to the last record in the product DB 111. If the present product corresponds to the last record, the automatic updating process ends; if not, the flow proceeds to Step S411.

In this manner, with respect to each product as the subject of questionnairing, questions adopted in the questionnaire are automatically updated. Accordingly, where a threshold is previously set with respect to a certain product, questions that are selected by the number of corporations greater than or equal to the threshold are immediately added to the questionnaire on the product. This saves the marketing staff member at the corporation 22 the labor of registering questions to be adopted in the questionnaire.

As described above, according to the embodiment of the present invention, the results of questionnairing on one corporation's product can be displayed for comparison with the results of questionnairing on other corporations' products. This makes it possible for the corporation to learn a general tendency of customers' preference in the market as well as the customers' evaluation of the individual products, and thus to accurately determine the factor which the corporation's product lacks and which is important in increasing the customer satisfaction.

Also, by following the same procedure (accessing the same Web site and entering the necessary items in the common screen) customers can respond to questionnaires on different corporations' products, making it easier for customers to respond to questionnaires. The individual corporations can therefore collect large amounts of questionnaires on products and obtain highly reliable results of questionnairing.

In the foregoing description, the threshold is set with respect to a product and is used as a common criterion for determining whether to adopt individual questions, but the threshold may be set with respect to each of questions. For example, a small threshold value may be set for a question which the corporation wishes to adopt even if the number of other corporations' products compared with its product is small, and a large threshold value may be set for a question with respect to which the corporation wishes to compare its product with a large number of other corporations' products.

Although in the foregoing description of the embodiment, questionnaires on products are collected by way of example, the present invention is equally applicable to questionnairing on services.

Also, in the above embodiment, the results of questionnairing on products belonging to the same product line are selected and displayed for comparison, but the results of questionnairing on products belonging to different product lines may be compared with one another.

During the automatic updating, moreover, the addition/deletion of questions to/from the questionnaire may be performed after approval of the addition/deletion is received from the corporation terminal at the corporation.

The processing function described above can be performed by a computer. In this case, a program is prepared in which are described processes for performing the function of the questionnaire collection server 100. The program is executed by a computer, whereupon the aforementioned processing function is accomplished by the computer. The program describing the processes may be recorded on a computer-readable recording medium. The computer-readable recording medium includes magnetic recording device, optical disc, magneto-optical recording medium, semiconductor memory, etc. Such a magnetic recording device may be hard disk drive (HDD), flexible disk (FD), magnetic tape, etc. As the optical disc, DVD (Digital Versatile Disc), DVD-RAM (Random Access Memory), CD-ROM (Compact Disc Read Only Memory), CD-R (Recordable)/RW (ReWritable) or the like may be used. The magneto-optical recording medium includes MO (Magneto-Optical disc) etc.

To distribute the program, portable recording media, such as DVD and CD-ROM, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer. Then, the computer loads the program from its storage device and performs processes in accordance with the program. The computer may load the program directly from the portable recording medium to perform processes in accordance with the program. Also, as the program is transferred from the server computer, the computer may sequentially perform processes in accordance with the program.

As described above, according to the present invention, customers' responses to questionnaires on products or services provided by a plurality of corporations are accepted, and the results of responses are displayed for comparison between the products or services provided by different corporations. Thus, responses to questionnaires on products or services of different corporations can be submitted to a common location or site, facilitating the submission of questionnaire responses, and also it is possible for a corporation to make comparison between the customer satisfaction with its product and that with other corporations' products based on the results of responses to the questions about multiple products or services.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A questionnaire collection method implemented by a computer connected to a network, comprising:
registering questions to be adopted in a questionnaire on each of products or services provided by a plurality of corporations;
accepting, via the network, responses of customers to the questions in the questionnaires on the products or the services; and
displaying results of responses to the questions for comparison between the products or the services provided by the plurality of corporations.

2. The questionnaire collection method according to claim 1, wherein,
when each of the questions is registered, a flag is set which indicates whether disclosure to other corporations of information about the response to the question is permitted or not, and
when the results of responses are displayed, the results of responses to only those questions whose flags indicate permission of the disclosure to other corporations are displayed for comparison.

3. The questionnaire collection method according to claim 1, wherein the customers who responded to the questionnaires are registered as participants in prize competition.

4. The questionnaire collection method according to claim 1, wherein, when the questions to be adopted in the questionnaire are registered, those questions which have been adopted by a number of corporations greater than or equal to a threshold set in advance with respect to the product or the service are preferentially adopted in the questionnaire on the product or the service.

5. The questionnaire collection method according to claim 4, wherein, when the questions to be adopted in the questionnaire are registered, those questions which have been adopted by a number of corporations greater than or equal to the threshold are preferentially displayed as suggested questions at a terminal device of a corporation which provides the product or the service.

6. The questionnaire collection method according to claim 4, further comprising determining whether or not the number of corporations adopting each of the questions has reached a number greater than or equal to the threshold set with respect to the product or the service, and adopting, in the questionnaire on the product or the service, a question adopted by a number of corporations greater than or equal to the threshold.

7. The questionnaire collection method according to claim 1, wherein the results of responses are transmitted via the network to a terminal device at a corporation which provides the product or the service as a target of the questionnaire, and are displayed for comparison at the terminal device.

8. The questionnaire collection method according to claim 1, wherein the responses of the customers to the questionnaires on the products or the services provided by the plurality of corporations are accepted following a uniform input procedure.

9. A questionnaire collection program for collecting questionnaires from customers,
wherein the questionnaire collection program causes a computer to perform the process of:
registering questions to be adopted in a questionnaire on each of products or services provided by a plurality of corporations;
accepting, via a network, responses of the customers to the questions in the questionnaires on the products or the services; and
displaying results of responses to the questions for comparison between the products or the services provided by the plurality of corporations.

10. A questionnaire collection apparatus for collecting questionnaires from customers, comprising:
registration means for registering questions to be adopted in a questionnaire on each of products or services provided by a plurality of corporations;
response accepting means for accepting, via a network, responses of the customers to the questions in the questionnaires on the products or the services; and
display means for displaying results of responses to the questions for comparison between the products or the services provided by the plurality of corporations.

11. A computer-readable recording medium having a questionnaire collection program recorded thereon for collecting questionnaires from customers, wherein the questionnaire collection program causes the computer to perform the process of:
registering questions to be adopted in a questionnaire on each of products or services provided by a plurality of corporations;
accepting, via a network, responses of the customers to the questions in the questionnaires on the products or the services; and
displaying results of responses to the questions for comparison between the products or the services provided by the plurality of corporations.
